(19) United States
(12) Patent Application Publication
(10) Pub. No.: US 2013/0315553 A1
(43) Pub. Date: Nov. 28, 2013

(54) APPARATUS FOR PRODUCING OPTICAL FIBER, METHOD FOR PRODUCING OPTICAL FIBER, AND OPTICAL FIBER PRODUCED BY METHOD

(71) Applicants: Masaki Takebe, Himeji-shi (JP); Tomoaki Mahiko, Himeji-shi (JP); Yoshinori Funaki, Himeji-shi (JP); Shinji Syuto, Himeji-shi (JP); Hitomi Omae, Himeji-shi (JP)

(72) Inventors: Masaki Takebe, Himeji-shi (JP); Tomoaki Mahiko, Himeji-shi (JP); Yoshinori Funaki, Himeji-shi (JP); Shinji Syuto, Himeji-shi (JP); Hitomi Omae, Himeji-shi (JP)

(73) Assignee: DAICEL CORPORATION, Osaka-shi, Osaka (JP)

(21) Appl. No.: 13/983,242

(22) PCT Filed: Jan. 27, 2012
(86) PCT No.: PCT/JP2012/051776

§ 371 Date: Aug. 1, 2013

(30) Foreign Application Priority Data
Feb. 2, 2011 (JP) 2011-021180

(51) Int. Cl. B29D 11/00; G02B 6/00

(52) U.S. Cl. CPC B29D 11/00663; G02B 6/00
USPC 385/141; 425/174.4; 264/1.27

(57) ABSTRACT

An apparatus produces an optical fiber by applying light to a photocurable composition and thereby curing the composition. The apparatus includes a nozzle for discharging the photocurable composition; a light irradiator for applying light to the fibrous photocurable composition discharged from the nozzle; and a controller that controls a light irradiation intensity at the nozzle orifice to 0.2 mW/cm² or less. The nozzle is preferably a double-tube nozzle having an outer tube; and an inner tube arranged inside the outer tube.

### TECHNICAL FIELD

The present invention relates to apparatuses for producing optical fibers. More specifically, it relates to an apparatus for producing an optical fiber by applying light to a photocurable composition to cure the composition to form a fiber (optical fiber). The present invention also relates to a method for producing an optical fiber by applying light to a photocurable composition to cure the composition to form a fiber. The present invention further relates to an optical fiber produced by the production method.

### BACKGROUND ART

There have been known optical fibers (plastic optical fibers) each including a core and a cladding both formed from resins (plastics). The plastic optical fibers have been increasingly used because they are lightweight, have satisfactory flexibility, are easy to handle, and are relatively inexpensive. With recently expanding situations and applications for optical fibers to be used, the plastic optical fibers have been required better thermal stability. Known plastic optical fibers having good thermal stability are exemplified by optical fibers obtained by curing photocurable resins.

To produce the plastic optical fibers, Patent Literature (PTL 1) discloses a production method of forming a fiber from a photocurable resin (cationically curable resin) while reacting the resin through the irradiation with ultraviolet light. In the production method, a liquid epoxy resin incorporated with an ultraviolet curing agent is placed in a heating container of a regular drawing apparatus and heated therein. To be discharged easily from the drawing nozzle to give a fiber having a uniform or constant diameter, the resin should be heated by a heater always at such a constant temperature as to have a low viscosity. According to the production method, a core to transmit light is initially prepared, and a cladding to protect the core is subsequently formed to cover the core surface.

### CITATION LIST

### Patent Literature

PTL 1: Japanese Unexamined Patent Application Publication (JP-A) No. S61-245109

### SUMMARY OF INVENTION

### Technical Problem

It has been found, however, that the production method disclosed in PTL 1 fails to produce an optical fiber having a uniform diameter merely by heating the photocurable resin (cationically curable resin) with the heater always at a constant temperature to allow the resin to have a low viscosity; and that the production method suffers from frequent fiber breakages (breakages of the optical fiber) and fails to continuously form an optical fiber.

The present inventors have found that the nonuniformity in optical fiber diameter is caused by instability of the viscosity of the photocurable composition (resin) discharged from the nozzle tip. The photocurable composition is exemplified by a composition including a photocurable resin as an essential component. They have also found that the instability of the photocurable composition viscosity occurs because the ultraviolet light impinges on the nozzle tip together with the photocurable composition present there, to partially cure the photocurable composition. PTL 1 never gives consideration to techniques for preventing impinging of light leaked from the ultraviolet light source on the vicinity of the nozzle and for reducing ultraviolet light that propagates through inside of the material (photocurable composition) flowing downward and reaches the vicinity of the nozzle tip.

An optical fiber is generally connected typically to a light-source device upon usage, and the core and the cladding constituting the optical fiber should be accurately concentric (their central axes should be accurately concentric). However, a method for producing an optical fiber by initially preparing a core, and subsequently covering the core with a cladding, as with the production method disclosed in PTL 1, hardly gives an optical fiber having a core and a cladding being concentric with each other.

Accordingly, an object of the present invention is to provide an apparatus for producing an optical fiber by applying light to a photocurable composition to cure the composition, which apparatus can give an optical fiber having a uniform diameter and enables continuous fiber forming without the occurrence of fiber breakage.

Another object of the present invention is to provide a method for producing an optical fiber by discharging a photocurable composition from a nozzle, and applying light to the discharged photocurable composition to cure the composition, which method can give an optical fiber having a uniform diameter and enables continuous fiber forming without the occurrence of fiber breakage.

Yet another object of the present invention is to provide an optical fiber which is produced by the production method, has a uniform diameter, and can be produced with satisfactory productivity.

### Solution to Problem

The present inventors have found that, upon production of an optical fiber by applying light to a photocurable composition to cure the composition, control as follows enables continuous forming of an optical fiber having a uniform diameter without the occurrence of fiber breakage. The control is a control of the irradiation intensity of light at a tip (orifice) of a nozzle within a specific range, which nozzle discharges the photocurable composition. The present invention has been made based on these findings.

The present invention provides an apparatus for producing an optical fiber (hereinafter also briefly referred to as an “optical-fiber production apparatus”) by applying light to a photocurable composition to cure the composition. The apparatus includes: a nozzle for discharging the photocurable composition into a fiber, the nozzle having an orifice; a light irradiator for applying light to the fibrous photocurable composition discharged from the nozzle; and a controller that controls an irradiation intensity of the light to 0.2 mW/cm² or less at the nozzle orifice.

In an embodiment of the optical-fiber production apparatus, the nozzle may be a double-tube nozzle including an outer tube; and an inner tube arranged inside the outer tube.

In another embodiment, the optical-fiber production apparatus may be configured to control a minimum θ of angles so as to satisfy a condition as specified by Expression (I), where the angles are formed between a direction and a plane, the direction is a direction of a light beam having a maximum irradiation intensity among light beams emitted from the light irradiator, the plane is a plane perpendicular to a discharging direction of the photocurable composition, and Expression (I) is expressed as follows:

θ≧ψ/2 (I)

wherein ψ represents a maximum of angles formed between light beams each having an irradiation intensity of 3% of the maximum irradiation intensity, the light beams belonging to the light beams emitted from the light irradiator.

The present invention further provides a method for producing an optical fiber (hereinafter also briefly referred to as an “optical-fiber production method”) by applying light to a photocurable composition to cure the composition. The method includes the step of: discharging a photocurable composition into a fiber through a nozzle and applying light to the fibrous photocurable composition discharged from the nozzle, the nozzle having an orifice, in which the step further includes controlling an irradiation intensity of the light to 0.2 mW/cm² or less at the nozzle orifice.

In an embodiment, the optical-fiber production method may further include the step of preparing, as the nozzle, a double-tube nozzle including an outer tube and an inner tube arranged inside the outer tube and produce an optical fiber having a core-cladding structure through the double-tube nozzle.

In another embodiment of the optical-fiber production method, the light may be applied to the photocurable composition so that a minimum θ of angles satisfies a condition as specified by Expression (I), where the angles are formed between a direction and a plane, the direction is a direction of a light beam having a maximum irradiation intensity among light beams emitted from the light irradiator, the plane is a plane perpendicular to a discharging direction of the photocurable composition, and Expression (I) is expressed as follows:

θ≧ψ/2 (I)

wherein ψ represents a maximum of angles formed between light beams each having an irradiation intensity of 3% of the maximum irradiation intensity, the light beams belonging to the light beams emitted from the light irradiator.

In addition and advantageously, the present invention provides an optical fiber produced by the production method.

### Advantageous Effects of Invention

The optical-fiber production apparatus according to the present invention has the configuration, thereby enables easy production of an optical fiber having a uniform diameter from a photocurable composition as a material, and enables continuous fiber forming without the occurrence of fiber breakage. The material photocurable composition is liquid at room temperature, and impurities in the material can be easily reduced by filtration. This enables easy production of a high-quality optical fiber.

The optical-fiber production method according to the present invention easily produces an optical fiber having a uniform diameter from a photocurable composition as a material and enables continuous fiber forming without the occurrence of fiber breakage during production.

The optical fiber according to the present invention is produced by the production method, thereby has a uniform diameter, can be produced with satisfactory productivity, and is advantageous in quality and cost. In addition, the optical fiber exhibits satisfactory thermal stability.

### BRIEF DESCRIPTION OF DRAWINGS

FIG. 1 is a schematic diagram illustrating an optical-fiber production apparatus; and production of an optical fiber using the production apparatus each as an embodiment of the present invention.

FIG. 2 is a schematic diagram (perspective view) illustrating an exemplary double-tube nozzle for use in an optical-fiber production apparatus as an embodiment of the present invention.

FIG. 3 is a schematic diagram (cross-sectional view taken along the line A-A in FIG. 2) of the double-tube nozzle for use in the optical-fiber production apparatus as an embodiment of the present invention.

FIG. 4 is a schematic diagram (radial cross-sectional view) of an exemplary double-tube nozzle including a positioning mechanism for use in an optical-fiber production apparatus as an embodiment of the present invention.

FIG. 5 is a schematic diagram (plane view) illustrating an exemplary light irradiator for use in an optical-fiber production apparatus as an embodiment of the present invention where irradiation is performed from three directions.

FIG. 6 is a schematic diagram (plan view) illustrating an exemplary light irradiator for use in an optical-fiber production apparatus as an embodiment of the present invention where irradiation is performed from two directions.

FIG. 7 is a schematic diagram (perspective view) illustrating an exemplary light-shielding tube for use in an optical-fiber production apparatus as an embodiment of the present invention.

FIG. 8 is a schematic diagram (perspective view) illustrating an exemplary light-shielding plate (disc light-shielding plate) for use in an optical-fiber production apparatus as an embodiment of the present invention.

FIG. 9 is a schematic diagram (perspective view) illustrating an exemplary light-shielding plate (conical light-shielding plate) for use in an optical-fiber production apparatus as an embodiment of the present invention.

FIG. 10 is a schematic diagram (side view) illustrating a divergence angle ψ of light emitted from a light irradiator.

FIG. 11 are schematic diagrams (side views) each illustrating a relationship between an angle θ and the light divergence angle ψ, where the angle θ is formed between a direction of a light beam having a maximum irradiation intensity and a plane perpendicular to the discharging direction of the photocurable composition. FIGS. 11(a) and 11(b) are schematic diagrams of the case where θ is ψ/2 or more and the case where θ is less than ψ/2, respectively.

FIG. 12 is a schematic diagram (side view) illustrating an exemplary light irradiator including an irradiation-angle regulatory mechanism for use in an optical-fiber production apparatus as an embodiment of the present invention.

FIG. 13 is a schematic diagram illustrating an optical-fiber production apparatus employing an epi-illumination system; and production of an optical fiber using the production apparatus, each as an embodiment of the present invention.

FIG. 14 is a schematic diagram illustrating an optical-fiber production apparatus (an optical-fiber production apparatus according to an embodiment of the present invention) used in Examples 1 and 2.

FIG. 15 is a schematic diagram illustrating an optical-fiber production apparatus used in Comparative Example 1.

### DESCRIPTION OF EMBODIMENTS

An optical-fiber production apparatus according to an embodiment of the present invention produces (forms as a fiber) an optical fiber by applying light to a photocurable composition to cure the composition. Specifically, an optical fiber produced by the optical-fiber production apparatus according to the present invention is an optical fiber that includes a cured article (resin cured article) cured from the photocurable composition.

Photocurable Composition

The photocurable composition is a composition that is cured upon light irradiation to give a resin cured article. The photocurable composition is exemplified by known or customary photocurable compositions such as radically polymerizable compositions, cationically polymerizable compositions, and anionically polymerizable compositions each of which is rapidly cured by light irradiation; and specific photocurable compositions mentioned later. Among them, the photocurable composition for use herein is preferably an ultraviolet-curable composition that is cured by ultraviolet irradiation.

The photocurable composition is liquid at room temperature (about 25° C.). Specifically, the photocurable composition is a liquid having fluidity at room temperature. The photocurable composition, when used as a material for an optical fiber, enables fiber forming at room temperature without by means of heat or a solvent to reduce the viscosity of the composition. The photocurable composition also easily gives a high-quality optical fiber because impurities can be readily removed therefrom by filtration. In contrast, a composition (resin composition) that is solid at room temperature, when used as a material for an optical fiber, hardly enables fiber forming at room temperature unless its viscosity is lowered by means of heat or a solvent, thus being disadvantageous in cost. Such compositions (resin compositions) that are solid at room temperature generally require a complicated operation to remove impurities therefrom.

A viscosity of the photocurable composition at 25° C. is not critical, as long as the composition being dischargeable from the nozzle, but is preferably from 10000 to 500000 cP, more preferably from 10000 to 100000 cP, and furthermore preferably from 50000 to 70000 cP. A photocurable composition having a viscosity of less than 10000 cP at 25° C., when discharged from the nozzle, may readily become droplets, and this may impede fiber forming. In contrast, a photocurable composition having a viscosity at 25° C. of more than 500000 cP may require reduction in viscosity by means of heat or a solvent so as to be discharged from the nozzle. The viscosity at 25° C. may be measured typically with an E-type viscometer (trade name “VISCONIC” supplied by Tokimec, Inc.) (rotor: 1°34′×R24, number of revolutions: 0.5 rpm, measurement temperature: 25° C.).

Optical-Fiber Production Apparatus

An optical-fiber production apparatus according to an embodiment of the present invention includes a nozzle that discharges a photocurable composition into a fiber, the nozzle having an orifice; and a light irradiator that applies light to the fibrous photocurable composition discharged from the nozzle and further includes a controller that controls an irradiation intensity of the light to 0.2 mW/cm² or less at the nozzle orifice. The optical-fiber production apparatus according to the present invention will be illustrated below with reference to the attached drawings according to necessity.

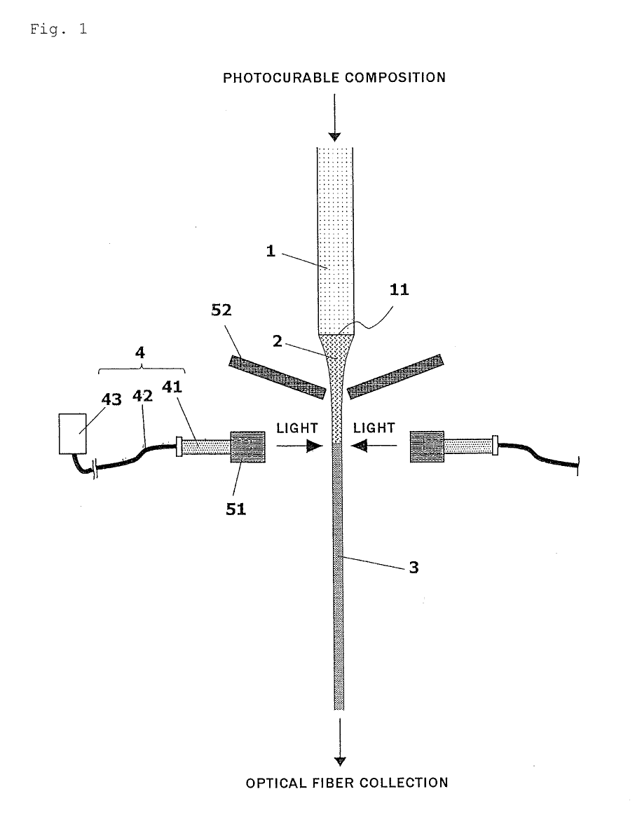

FIG. 1 is a schematic diagram illustrating an optical-fiber production apparatus; and production of an optical fiber using the production apparatus each as an embodiment of the present invention. With reference to FIG. 1, the optical-fiber production apparatus according to the present invention includes a nozzle 1 and light irradiators 4. The nozzle 1 has an orifice 11 at the tip thereof. The light irradiators 4 are arranged so as to emit light toward below the orifice 11. The light irradiators 4 illustrated in FIG. 1 each include a light source 43 that outputs light; a light guide 42 that transmits the light; and a light guide tip 41 that emits the light from an end (output terminal) thereof. The light irradiator in the right hand in FIG. 1 is illustrated while omitting a part of the light guide and the light source, but represents one identical to the left-hand light irradiator 4. This is also applied to the other drawings. Reference signs 51 and 52 in FIG. 1 stand for light-shielding members (51: light-shielding tube, 52: light-shielding plate). The light-shielding members serve as a controller to control an irradiation intensity of the light to 0.2 mW/cm² or less at the orifice 11 of the nozzle 1.

To produce an optical fiber using the optical-fiber production apparatus illustrated in FIG. 1, the nozzle 1 initially discharges a photocurable composition 2 vertically downward from the orifice 11, and the light irradiator 4 applies light to the photocurable composition 2 trailing down from the nozzle 1. This cures the photocurable composition 2 to give an optical fiber 3.

Nozzle

The nozzle in the optical-fiber production apparatus according to the present invention functionally passes the photocurable composition through inside thereof and discharges the composition from the orifice. The photocurable composition discharged from the nozzle orifice generally forms a filament (fiber) having a small diameter.

The nozzle has a tubular (hollow columnar) shape and has an orifice at a tip (one end) thereof, from which orifice the photocurable composition is discharged. Though not limited, the other end of the nozzle opposite to the orifice is generally connected, via a suitable tube according to necessity, to a metering pump or a reservoir that stores the photocurable composition.

The nozzle may have any shape not critical, as long as being tubular, and may have a cylindrical or rectangular tubular (prismatic) shape. Of the shapes, the nozzle preferably has a cylindrical shape so as to form an optical fiber having a low transmission loss.

A material for the nozzle is not critical and is exemplified by SUS, aluminum, and resins. Among them, SUS is preferred for satisfactory durability and strength.

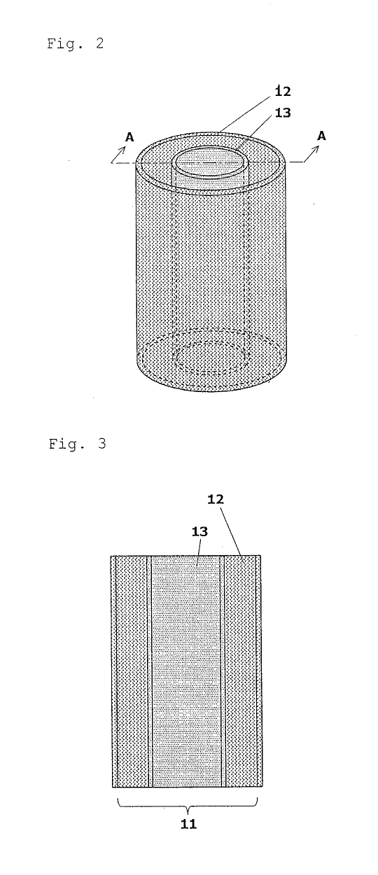

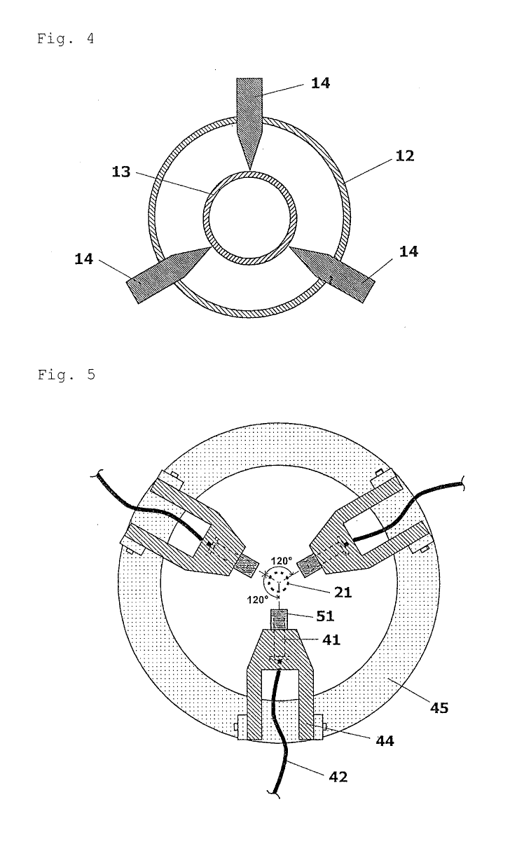

The nozzle is preferably a double-tube nozzle having an outer tube; and an inner tube arranged inside the outer tube. The double-tube nozzle is preferred for providing the concentricity of a core and a cladding in the resulting optical fiber. More specifically, the term “double-tube nozzle” as used herein refers to a nozzle (particularly a cylindrical nozzle) having a double-tube structure including a tubular (particularly, cylindrical) outer tube; and a tubular (particularly, cylindrical) inner tube arranged inside the outer tube and having an outer diameter smaller than the inner diameter of the outer tube. FIGS. 2 and 3 are schematic diagrams illustrating an exemplary double-tube nozzle, in which FIG. 2 depicts a perspective view; and FIG. 3 depicts a cross-sectional view taken along the line A-A in FIG. 2. In FIGS. 2 and 3, reference signs 12 and 13 stand for an outer tube and an inner tube, respectively. When the double-tube nozzle is used, a photocurable composition for the formation of the core (also referred to as a “core composition”) and another photocurable composition for the formation of the cladding (also referred to as a “cladding composition”) are prepared. The double-tube nozzle can discharge the core composition and the cladding composition simultaneously from the nozzle orifice 11. This can be achieved by feeding the core composition through the inside of the inner tube 13 and simultaneously feeding the cladding composition through space between the outer tube 12 and the inner tube 13. Next, light is applied to the photocurable compositions (core composition and cladding composition) to cure them. This gives an optical fiber having a core-cladding structure in one step. The resulting optical fiber has a double (two-layer) structure including the core and the cladding.

Diameters (inner diameter and outer diameter) of the outer tube and of the inner tube in the double-tube nozzle are not critical and can be suitably selected according typically to the core diameter and cladding diameter of the optical fiber to be produced, as well as the viscosities and discharging rates of the photocurable compositions. Specifically, the outer tube in the double-tube nozzle may have an inner diameter of preferably from 2 to 8 mm and more preferably from 2.4 to 5.4 mm. The inner tube in the double-tube nozzle may have an outer diameter of typically preferably from 1 to 7 mm and more preferably from 1.5 to 4 mm and have an inner diameter of typically preferably from 0.6 to 6.4 mm and more preferably from 1.1 to 3.4 mm.

The outer tube and the inner tube in the double-tube nozzle preferably have axes (central axes) concentric with each other at least at the tip including the orifice. This double-tube nozzle enables easy production of an optical fiber including a core and a cladding being concentric with each other. The resulting concentric optical fiber can exhibit satisfactory reliability upon connection to another piece of the optical fiber and connection to another device (e.g., a connector or a light source).

To allow the outer tube and the inner tube to be concentric with each other, the double-tube nozzle preferably has a regulatory mechanism for positioning the inner tube inside of the outer tube (hereinafter also referred to as a “positioning mechanism”). The positioning mechanism is not limited, as long as being capable of positioning the inner tube. Among such positioning mechanisms, one or more screws (adjusting screws) can be used as a simple positioning mechanism. The adjusting screws are arranged so as to penetrate the outer tube and to come in contact with the outer surface of the inner tube at their tips. FIG. 4 is a schematic diagram illustrating an embodiment of a double-tube nozzle including a positioning mechanism and depicts a radial cross-sectional view of the double-tube nozzle. Reference sign 14 in FIG. 4 stands for an adjusting screw. In the embodiment illustrated in FIG. 4, three adjusting screws are arranged so as to come in contact with the inner tube at their tips at regular intervals to constitute the positioning mechanism. The inner tube inside the outer tube can be positioned by regulating screw-in lengths of the adjusting screws respectively. However, conditions and parameters such as size, number, and arrangement of adjusting screw(s) to be used are not limited to the above.

The nozzle to be used in the optical-fiber production apparatus according to the present invention is not limited to the double-tube nozzle and may be any of a single-tube nozzle and a multi-tube nozzle structurally having three or more tubes. The nozzle can be suitably selected according typically to the structure and shape of an optical fiber to be produced.

Light Irradiator

The light irradiator for use in the optical-fiber production apparatus according to the present invention functionally applies light to the fibrous photocurable composition discharged from the nozzle to cure the composition. The fibrous photocurable composition extending from the nozzle orifice, when cured, gives an optical fiber.

The light to be applied by the light irradiator is not limited, as long as one capable of curing the photocurable composition, but is exemplified by ultraviolet rays, infrared rays, visible rays, and electron beams. Among them, ultraviolet rays are preferred to allow the use of common photoinitiators. Specifically, the light irradiator for use in the optical-fiber production apparatus according to the present invention is preferably an ultraviolet irradiator.

The light irradiator can be any of known or customary light irradiators that emit (radiate) light (particularly, an ultraviolet ray) capable of curing the photocurable composition and apply the light to the photocurable composition. Specifically, when the light irradiator is to emit an ultraviolet ray (ultraviolet irradiator), it can employ any of light sources such as high-pressure mercury lamps, ultra-high-pressure mercury lamps, xenon lamps, carbon arc, metal halide lamps, sunlight, LED lamps, and laser systems. The light irradiator can also be, for example, one including any of these light sources in combination with a light guide for transmitting light outputted from the light source; or one including the light source and the light guide in combination with any of optical systems such as lenses and mirrors.

As used herein, a part of the light irradiator which outputs light is also referred to as an “outputting part”. Typically, an outputting part in the light irradiator 4 illustrated in FIG. 1 corresponds to a distal end (output terminal) of the light guide tip 41.

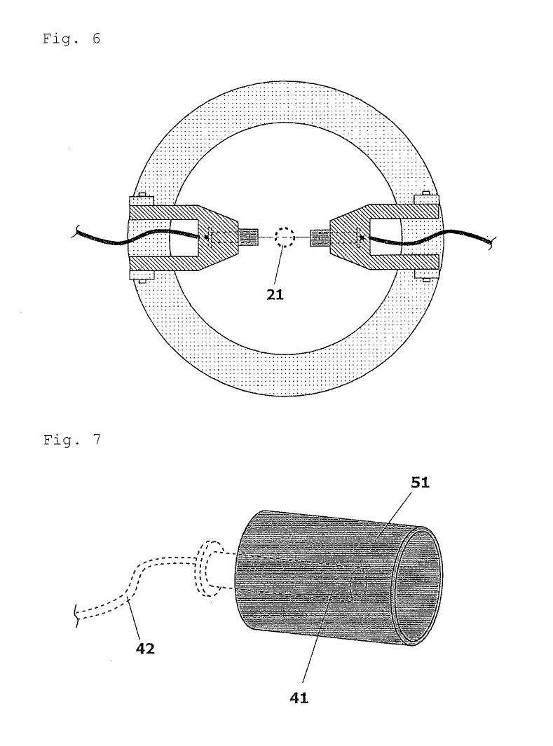

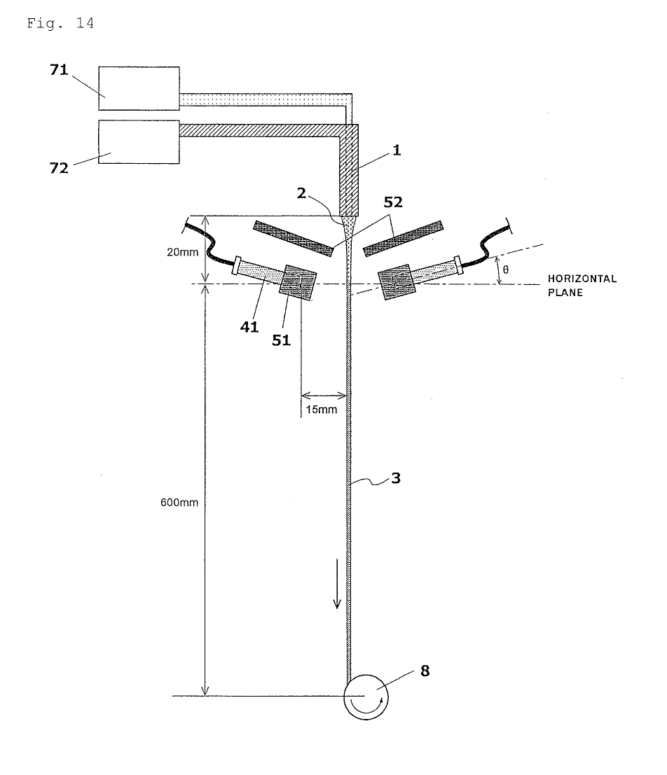

In the optical-fiber production apparatus according to the present invention, a way to apply light to the photocurable composition using the light irradiator is not limited. Typically, the arrangement and number of outputting part(s) of the light irradiator are not limited. However, outputting part(s) of the light irradiator is particularly preferably arranged so as to apply light to the photocurable composition uniformly. FIG. 5 is a schematic diagram (plan view) illustrating an exemplary light irradiator for use in the optical-fiber production apparatus according to the present invention. The light irradiator illustrated in FIG. 5 emits light from three directions toward below the nozzle orifice and applies the light to the photocurable composition. The light irradiator has outputting parts (output terminals of the light guide tips 41) arranged equidistantly from the photocurable composition and arranged at regular intervals with one another. In FIG. 5, reference sign 21 stands for a position through which the photocurable composition passes; and reference sings 44 and 45 stand for bases (supports) for fixing the light guide tips 41 of the light irradiator in the optical-fiber production apparatus according to the present invention. However, the light irradiator is not limited to this and may be any of: one that applies light from two directions as in the light irradiator illustrated in FIG. 6; one that applies light from only one direction; and one that applies light from four or more directions. The light irradiator is not limited to one that emits light toward below the nozzle orifice, but may be one that emits (outputs) light from above the nozzle orifice (e.g., see FIG. 13).

The light irradiator may be used in combination with an appropriate optical system according to necessity, so as to effectively apply light to the photocurable composition. Specifically typically, light from the light irradiator can be collected through a condenser (e.g., convex lens or cylindrical lens) to apply light to the photocurable composition at a higher intensity; and/or light once applied to the photocurable composition is reflected by a mirror (reflector) to be applied again to the photocurable composition. The optical system, when used, can make efficient use of light to produce an optical fiber with better productivity. The optical system is not limited to the above and can be, for example, any of optical systems generally used in known or customary optical equipment.

Controller

The optical-fiber production apparatus according to the present invention further includes, in addition to the nozzle and the light irradiator, the controller. The controller is provided for controlling a light irradiation intensity at the nozzle orifice (hereinafter simply referred to as a “light irradiation intensity at the orifice”) to 0.2 mW/cm² or less.

As used herein the term “light irradiation intensity at the orifice” refers to a light irradiation intensity (in mW/cm²) measured at the nozzle orifice. In the measurement, light is emitted from the light irradiator in the optical-fiber production apparatus according to the present invention having the same structure (configuration) and under the same conditions with those of the production of an optical fiber, except for feeding no photocurable composition. The measurement of the irradiation intensity can be performed by any method not limited, such as a method using a power meter (trade name “UV Meter UTI-250” supplied by Ushio Inc.).

The light irradiation intensity at the orifice is not critical, as long as being controlled to 0.2 mW/cm² or less, but is preferably 0.1 mW/cm² or less. This is preferred so as to obtain an optical fiber having a uniform diameter and to prevent fiber breakage during production. Light, if applied at a light irradiation intensity at the orifice of more than 0.2 mW/cm², causes proceeding of a curing reaction (polymerization reaction) of the photocurable composition at the orifice at the nozzle tip, and this causes the photocurable composition in the vicinity of the orifice to have a varying viscosity and/or causes the orifice to be clogged with the photocurable composition. As a result, the photocurable composition discharged from the nozzle may disadvantageously have an unstable fiber diameter, fail to give an optical fiber having a uniform diameter, and/or may cause frequent fiber breakages during production. Thus, an optical fiber is produced with poor productivity.

The controller is not limited, as long as capable of controlling the light irradiation intensity at the orifice to 0.2 mW/cm² or less.

The optical-fiber production apparatus according to the present invention employs, as a material for an optical fiber to be produced, a photocurable composition that is liquid at room temperature. This requires light irradiation and curing of the photocurable composition to be performed in such relatively early stages that the photocurable composition discharged from the nozzle can maintain its shape as a filament (fiber). For this reason, the optical-fiber production apparatus according to the present invention should arrange the nozzle orifice as close as possible to a portion of the photocurable composition to be irradiated with light. The apparatus inevitably has such a structure that light to be applied to the photocurable composition can be readily reach the vicinity of the orifice. From this viewpoint, the controller is advantageously any of light-shielding members as follows. Typically, the light-shielding members can suppress light divergence and/or can cast a shadow on the orifice when arranged between the light irradiator outputting part and the nozzle orifice.

FIG. 7 illustrates a tubular light-shielding member 51 (hereinafter also referred to as a “light-shielding tube”) as an embodiment of the light-shielding members. The light-shielding tube 51 is arranged to surround the light irradiator outputting part (output terminal of the light guide tip 41), thereby prevents the emitted light from diverging more than necessary, and suppresses the light from propagating to the nozzle orifice (see FIG. 1). Diameter, length, and other dimensions of the light-shielding tube are not limited and can be suitably selected according typically to the dimensions of the light irradiator outputting part.

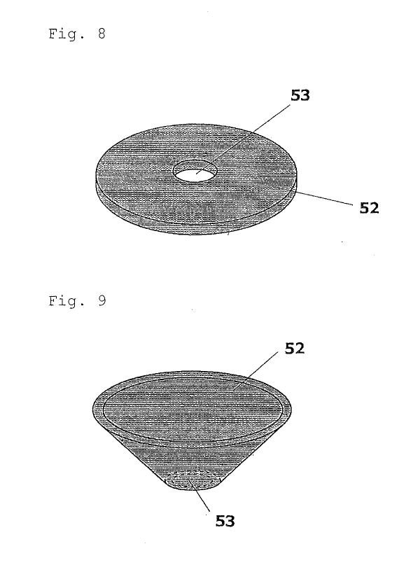

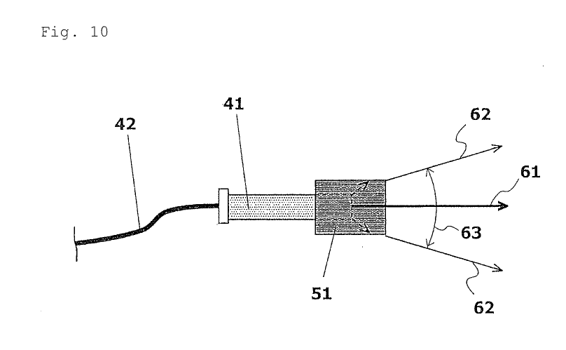

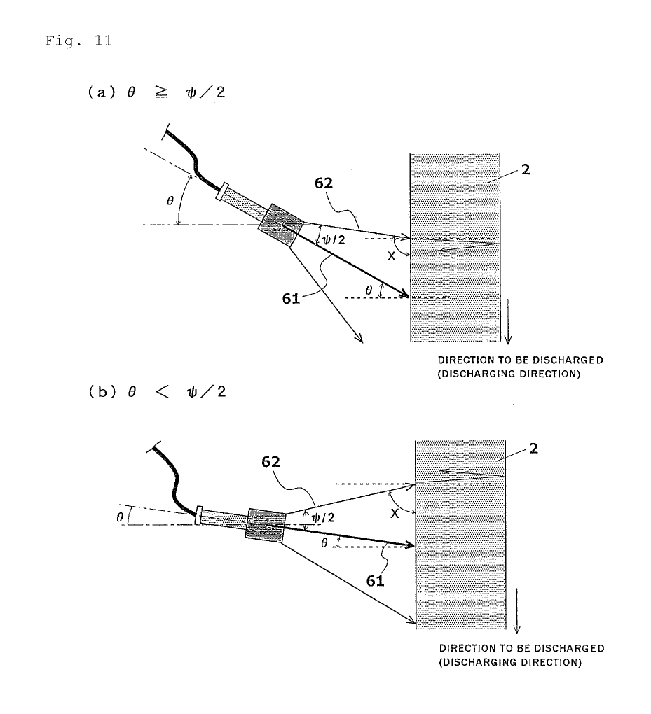

The light-shielding members for use herein are also exemplified by a sheet-like light-shielding member (hereinafter also referred to as a “light-shielding plate”) that can be arranged between the light irradiator outputting part and the nozzle orifice (see FIG. 1; reference sign 52 in FIG. 1). Such a light-shielding plate, when used, can cut off weak light that still leaks out even when the light irradiator outputting part is surrounded by a light-shielding tube. The light-shielding plate and the light-shielding tube may be advantageously used in combination. The light-shielding plate is not limited on its shape and size, but may be exemplified by a disc light-shielding plate illustrated in FIG. 8; and a conical light-shielding plate illustrated in FIG. 9. For easy installation, the light-shielding plate preferably has a hole (puncture) (reference sign 53 in FIGS. 8 and 9) to pass the photocurable composition therethrough.

The light-shielding members such as the light-shielding tube and the light-shielding plate may be formed from any material which is exemplified by, but not limited to, SUS, aluminum, resins, and papers. The light-shielding members are preferably, but not limitatively, black for the prevention of light reflection.

Control of Light Irradiation Angle

In the optical-fiber production apparatus according to the present invention, a light irradiation angle with respect to the photocurable composition is preferably controlled within a specific range. This is preferred typically for obtaining an optical fiber having a uniform diameter and suppressing fiber breakage further effectively and advantageously. Specifically, in the optical-fiber production apparatus according to the present invention, a minimum θ of angles is preferably controlled so as to satisfy a condition as specified by Expression (I), where the angles are formed between a direction and a plane (flat plane), the direction is a direction of a light beam having a maximum irradiation intensity among light beams emitted from the light irradiator, the plane is a plane perpendicular to a discharging direction of the photocurable composition, and Expression (I) is expressed as follows:

θ≧ψ/2 (I)

wherein ψ represents a maximum of angles formed between light beams each having an irradiation intensity of 3% of the maximum irradiation intensity, the light beams belonging to the light beams emitted from the light irradiator. The angle ψ is hereinafter also referred to as a “divergence angle”.

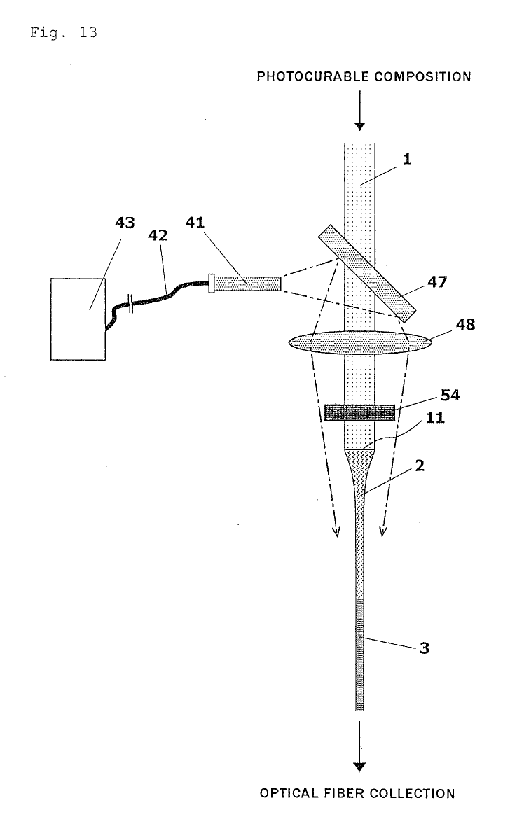

Strictly, a light beam having a maximum irradiation intensity (hereinafter also referred to as a “maximum-intensity light”) among light beams emitted from the light irradiator (light irradiator outputting part) can be identified by measuring an intensity distribution of light emitted from the outputting part. Generally, a light beam emitted toward the front of the light irradiator outputting part (e.g., the output terminal of the light guide tip) is defined as a maximum-intensity light. The light guide tip may be tilted toward the discharging direction of the photocurable composition (e.g., downward) by an angle θ with respect to a plane (generally a horizontal plane) orthogonal to the discharging direction of the photocurable composition. In this case, a minimum of angles formed between the maximum-intensity light direction and a plane perpendicular to the discharging direction of the photocurable composition corresponds to the angle θ (see, for example, FIG. 11(a)).

In Expression (I), ψ represents a divergence angle, i.e. a maximum of angles formed between light beams each having an irradiation intensity of 3% of the maximum irradiation intensity (irradiation intensity of the maximum-intensity light), among light beams emitted from the light irradiator (light irradiator outputting part). When the light-shielding tube is placed around the outputting part upon production of an optical fiber, the angle ψ refers to a divergence angle of light emitted (outputted) from the outputting part surrounded by the light-shielding tube. A smaller (narrower) divergence angle refers to a higher directivity of light emitted from the light irradiator.

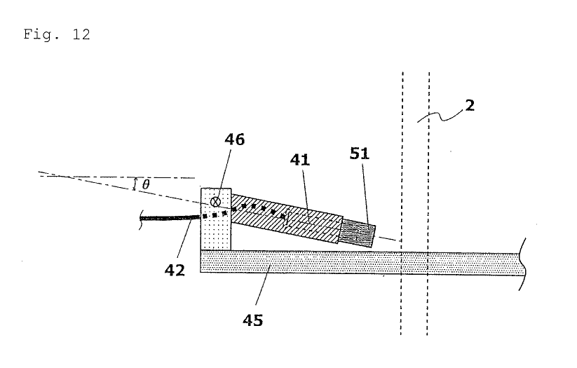

FIG. 10 is a schematic diagram (side view) illustrating the divergence angle ψ of light emitted from the light irradiator in an embodiment using a light-shielding tube. In FIG. 10, reference sign 61 stands for a maximum-intensity light; and reference sign 62 stands for a light beam having an irradiation intensity of 3% of that of the maximum-intensity light. With reference to FIG. 10, the divergence angle ψ is defined as a maximum 63 of angles formed between light beams each having an irradiation intensity of 3% of that of the maximum-intensity light. The divergence angle ψ may generally decrease when the light-shielding tube is placed around the outputting part.

The divergence angle ψ can be derived typically by measuring a light intensity distribution at a constant distance (e.g., 1.5 cm) from the outputting part. The light intensity distribution can be measured typically by measuring light intensities while gradually moving an optical receiver of an ultraviolet meter from the irradiated light center (at the front of the outputting part center) toward the periphery.

In a preferred embodiment, the minimum θ of angles formed between the direction of the maximum-intensity light emitted from the light irradiator and the plane perpendicular to the discharging direction of the photocurable composition is controlled so as to satisfy the condition specified by Expression (I). Typically, the optical-fiber production apparatus according to this embodiment can more effectively and advantageously give an optical fiber having a uniform diameter and suppress fiber breakage during production. This is because as follows.

FIG. 11 are schematic diagrams (side views) each illustrating a relationship between an angle θ and a light divergence angle ψ, where the angle θ is a minimum of angles formed between a direction of the maximum-intensity light and a plane perpendicular to the discharging direction of the photocurable composition. FIG. 11(a) is a schematic diagram of the case where θ is equal to or more than ψ/2, namely, θ and ψ satisfy the condition as specified by Expression (I). In this case, an angle X is expressed as “90°+(θ−ψ/2)”. The angle X is defined as an angle formed between a (nozzle-side) light beam 62 having an irradiation intensity of 3% of the maximum intensity and an incidence plane of the light beam 62 with respect to the photocurable composition. The light beam 62 belongs to light beams emitted from the light irradiator. When θ is equal to or more than ψ/2 (i.e., [θ−ψ/2]≧0), the angle X is 90° or obtuse. The (nozzle-side) light beam 62 having an irradiation intensity of 3% of the maximum intensity enters the photocurable composition perpendicularly or at a tilt toward the discharging direction. In this case, the (nozzle-side) light beam 62 having an irradiation intensity of 3% of the maximum intensity propagates in the photocurable composition toward the discharging direction; whereas only light beams having an irradiation intensity of less than 3% of the maximum intensity can propagate toward the nozzle. This impedes proceeding of a curing reaction of the photocurable composition in the vicinity of the nozzle orifice, thereby advantageously effectively gives an optical fiber having a uniform diameter, and suppresses fiber breakage. By contrast, when the angles θ and ψ do not satisfy the condition specified by Expression (I), X is an acute angle (see FIG. 11(b)), and at least light beams each having an irradiation intensity of 3% of the maximum intensity may propagate toward the nozzle direction and adversely affect optical fiber production.

The optical-fiber production apparatus according to the present invention preferably has a mechanism for regulating the irradiation angle of light emitted from the light irradiator (hereinafter also referred to an “irradiation-angle regulatory mechanism”). This mechanism is provided so as to control the light irradiation angle, specifically, the minimum θ of angles formed between the maximum-intensity light direction and the plane perpendicular to the discharging direction of the photocurable composition. FIG. 12 is a schematic diagram illustrating an exemplary light irradiator including an irradiation-angle regulatory mechanism for use in the optical-fiber production apparatus according to the present invention. The light irradiator illustrated in FIG. 12 includes a screw 46 (angle-adjusting screw) as the irradiation-angle regulatory mechanism and can freely adjust the angle of the light guide tip.

Others

The optical-fiber production apparatus according to the present invention may further employ one or more devices or mechanisms in addition to the nozzle, the light irradiator, and the controller. Typically, the apparatus may further employ a metering pump for controlling the amount (discharging rate) of the photocurable composition discharged from the nozzle. Control of the photocurable composition discharging rate enables control of the optical fiber diameter. In general, the photocurable composition (optical fiber) has an increasing fiber diameter with an increasing discharging rate. When a double-tube nozzle is used, the core diameter and the cladding diameter can be flexibly controlled by independently controlling the discharging rates of the core composition and the cladding composition.

The optical-fiber production apparatus according to the present invention may also employ a winder (reeling machine) for winding and collecting the produced optical fiber. Control of the take-up speed of the optical fiber by the winder enables control of the optical fiber diameter. The photocurable composition (optical fiber) generally has a decreasing fiber diameter with an increasing take-up speed.

Where necessary, the optical-fiber production apparatus according to the present invention may further include one or more other appliances or devices such as a heating unit, a cooling unit, a fiber-diameter measuring device, and a fiber-tension measuring device.

Other Embodiments of Optical-Fiber Production Apparatus

In an embodiment of the optical-fiber production apparatus according to the present invention, the light irradiator outputting part(s) is arranged below the nozzle orifice, as mentioned above (see, for example, FIG. 1). In another embodiment, the light irradiator outputting part(s) is arranged above the nozzle orifice and emits light from above the orifice. The apparatus according to this embodiment is hereinafter also referred to as an “optical-fiber production apparatus of epi-illumination system”. FIG. 13 is a schematic diagram illustrating an optical-fiber production apparatus of epi-illumination system; and production of an optical fiber using the production apparatus each as an embodiment of the present invention. The optical-fiber production apparatus according to the present invention illustrated in FIG. 13 includes a nozzle 1 and a light irradiator. The light irradiator is arranged so as to apply light from above the orifice 11 at the tip of the nozzle 1. The light irradiator in FIG. 13 includes a light source 43 that outputs light; a light guide 42 that transmits the light; and a light guide tip 41 that emits light from an end (output terminal) thereof and further includes a reflector 47 that reflects light downward, which light is emitted from the output terminal of the light guide tip 41; and a condenser (condensing lens) 48 that condenses the reflected light. Reference sign 54 in FIG. 13 stands for a ring-shaped light-shielding member (hereinafter also referred to as a “light-shielding ring”). Such a light-shielding ring, when attached above the nozzle tip, controls an irradiation intensity of light to 0.2 mW/cm² or less at the orifice 11 of the nozzle 1.

An optical-fiber production apparatus of epi-illumination system, when used as the optical-fiber production apparatus according to the present invention, advantageously enables easy shadowing on the nozzle orifice by using the light-shielding ring 54 as illustrated in FIG. 13, and enables more efficient reduction of light irradiation intensity at the nozzle orifice. On the other hand, however, the production apparatus suffers from a relatively large distance between the light irradiator outputting part and the photocurable composition, and this disadvantageously impedes the application of high-intensity light to the photocurable composition and impedes improvements in productivity. Even in the epi-illumination system, however, the disadvantages can be solved typically by using a light irradiator including an outputting part below the nozzle orifice in combination with the system according to necessity.

Optical-Fiber Production Method

An optical-fiber production method according to an embodiment of the present invention produces an optical fiber by applying light to a photocurable composition to cure the composition, includes the step of discharging a photocurable composition into a fiber through a nozzle and applying light to the fibrous photocurable composition discharged from the nozzle. This step includes controlling a light irradiation intensity at the nozzle orifice to 0.2 mW/cm² or less.

The nozzle may be exemplified by, but not limited to, those exemplified in the description of the optical-fiber production apparatus according to the present invention. Among them, the optical-fiber production method according to the present invention preferably employs, as the nozzle, a double-tube nozzle having an outer tube; and an inner tube arranged inside the outer tube to produce an optical fiber having a core-cladding structure. The double-tube nozzle is preferably exemplified by those exemplified in the description of the optical-fiber production apparatus according to the present invention. The method, when employing the double-tube nozzle, enables simultaneous discharge of a core composition and a cladding composition from the nozzle. The method can produce an optical fiber having a core-cladding structure in one step by subsequently applying light to the photocurable compositions (core composition and cladding composition) to cure the compositions.

The light irradiator is not limited, as long as capable of emitting or outputting light that can cure the photocurable composition(s), but may be exemplified by those exemplified in the description of the optical-fiber production apparatus according to the present invention.

In the optical-fiber production method according to the present invention, initially, a photocurable composition is discharged from the nozzle orifice. The discharging may be performed typically vertically downward. Though not critical, the photocurable composition may be discharged at a discharging rate (feed rate) of typically preferably from 0.3 to 1 mL/min, and more preferably from 0.375 to 0.6 mL/min. Control of the photocurable composition discharging rate enables control of the optical fiber diameter. The double-tube nozzle, when employed as the nozzle, can discharge the core composition and the cladding composition simultaneously. Though not critical, a total discharging rate of the core composition and the cladding composition in this embodiment is typically preferably from 0.3 to 1 mL/min and more preferably from 0.375 to 0.6 mL/min. Independent control of the discharging rates of the core composition and the cladding composition enables independent control of the core diameter and the cladding diameter in the optical fiber. The control of the discharging rate(s) may be performed typically with the metering pump(s) exemplified in the description of the optical-fiber production apparatus according to the present invention.

Next, the light irradiator applies light to the photocurable composition(s) discharged from the nozzle orifice. Though not critical, the light herein may be applied at an irradiation intensity of preferably 1000 to 5000 mW/cm² and more preferably from 1500 to 2000 mW/cm² in terms of irradiation intensity with respect to the photocurable composition. Light irradiation procedures or conditions (e.g., the number and arrangement of the light irradiator outputting part(s)) are not limited and may be exemplified by the irradiation procedures exemplified in the description of the optical-fiber production apparatus according to the present invention. The method may further employ a suitable optical system upon light irradiation.

In the optical-fiber production method according to the present invention, control of the light irradiation intensity at the nozzle orifice to 0.2 mW/cm² or less is important in the step (the step of discharging the photocurable composition from nozzle and applying light to the discharged photocurable composition). This gives an optical fiber having a uniform diameter, whose production can be performed with satisfactory productivity without fiber breakage. Means (process) for controlling the irradiation intensity is effectively represented by, but not limited to, the use of any of the light-shielding members (e.g., the light-shielding tube, light-shielding plate, and light-shielding ring) exemplified in the description of the optical-fiber production apparatus according to the present invention.

In a preferred embodiment of the optical-fiber production method according to the present invention, a light irradiation angle with respect to the photocurable composition is controlled. Specifically, the optical-fiber production method according to the present invention preferably applies light to the photocurable composition so that a minimum θ of angles satisfies a condition as specified by Expression (I), where the angles are formed between a direction and a plane, the direction is a direction of a light beam having a maximum irradiation intensity (maximum-intensity light) among light beams emitted from the light irradiator, the plane (flat face) is a plane perpendicular to the discharging direction of the photocurable composition, and Expression (I) is expressed as follows:

θ≧ψ/2 (I)

wherein ψ represents a maximum of angles (divergence angle) formed between light beams each having an irradiation intensity of 3% of the maximum irradiation intensity, the light beams belonging to the light beams emitted from the light irradiator.

The angle θ is a minimum θ of angles formed between the maximum-intensity light direction and the plane perpendicular to the discharging direction of the photocurable composition. The angle θ may be controlled typically by a tilt angle of the light guide tip of the light irradiator toward the discharging direction of the photocurable composition (e.g., downward) with respect to a plane (generally a horizontal plane) orthogonal to the discharging direction of the photocurable composition, as described above. The angle ψ (divergence angle) can be derived by the process as above. Control of the light irradiation angle in the above manner can further advantageously and effectively give an optical fiber having a uniform diameter and suppress fiber breakage. This is because as described in the description of the optical-fiber production apparatus according to the present invention.

An optical fiber obtained by curing the photocurable composition by the optical-fiber production method according to the present invention can be collected or retrieved typically, but not limitatively, by winding the fiber suitably. Though not critical, the take-up speed herein is typically preferably from 10 to 1000 mm/second and more preferably from 100 to 500 mm/second. Control of the take-up speed enables control of the diameter of the resulting optical fiber. Control of the take-up speed may be achieved typically by using the winder.

The optical-fiber production method according to the present invention may suitably employ one or more other appliances or devices such as a heating unit, a cooling unit, a fiber-diameter measuring device, and a fiber-tension measuring device, as in the optical-fiber production apparatus according to the present invention.

Optical Fiber

An optical fiber according to an embodiment of the present invention is produced by the method (the optical-fiber production method according to the present invention). A photocurable composition(s) for use as a material for the optical fiber according to the present invention is not limited, but preferably essentially includes a polymer or copolymer of an oxetane-ring-containing (meth)acrylic ester compound as specified by Formula (1) mentioned below. This is preferred from the viewpoints of thermal stability and mechanical properties. In a further preferred embodiment, the optical fiber according to the present invention includes a core and a cladding, in which a photocurable composition for forming the core and a photocurable composition for forming the cladding are both photocurable resin compositions each essentially including a polymer or copolymer of the oxetane-ring-containing (meth)acrylic ester compound represented by Formula (1).

More specifically, the photocurable resin composition(s) preferably essentially includes a cationically polymerizable resin or a radically polymerizable resin. The cationically polymerizable resin is obtained by subjecting an oxetane-ring-containing (meth)acrylic ester compound represented by Formula (1) to radical polymerization alone or in combination with another radically polymerizable compound. The radically polymerizable resin is obtained by subjecting the oxetane-ring-containing (meth)acrylic ester compound represented by Formula (1) to cationic polymerization alone or in combination with another cationically polymerizable compound.

The photocurable resin composition(s) is particularly preferably a cationically polymerizable resin composition(s) for having a low viscosity and exhibiting excellent workability. The cationically polymerizable resin composition(s) is a photocurable resin composition(s) essentially including a cationically polymerizable resin obtained by subjecting the oxetane-ring-containing (meth)acrylic ester compound represented by Formula (1) to radical polymerization alone or in combination with another radically polymerizable compound.

Oxetane-Ring-Containing (Meth)Acrylic Ester Compound

The oxetane-ring-containing (meth)acrylic ester compound is represented by Formula (1) expressed as follows:

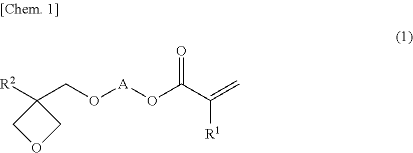

wherein R¹ and R² are the same as or different from each other and each represent a hydrogen atom or an alkyl group; and “A” represents a linear or branched chain alkylene group having 2 to 20 carbon atoms.

In Formula (1), the alkyl groups as R¹ and R² are preferably alkyl groups having 1 to 6 carbon atoms, which are exemplified by linear alkyl groups having 1 to 6 carbon atoms, such as methyl group, ethyl group, propyl group, butyl group, pentyl group, and hexyl group, of which those having 1 to 3 carbon atoms are more preferred; and branched chain alkyl groups having 1 to 6 carbon atoms, such as isopropyl group, isobutyl group, s-butyl group, t-butyl group, isopentyl group, s-pentyl group, t-pentyl group, isohexyl group, s-hexyl group, and t-hexyl group, of which those having 1 to 3 carbon atoms are more preferred. R¹ is preferably hydrogen atom or methyl group; and R² is preferably methyl group or ethyl group.

In Formula (1), “A” represents a linear or branched chain alkylene group having 2 to 20 carbon atoms. To form an optical fiber having thermal stability and flexibility both at satisfactory levels, “A” is preferably a linear alkylene group represented by Formula (a1) or a branched chain alkylene group represented by Formula (a2). The rightmost end of Formula (a2) is bonded to the oxygen atom constituting the ester bond. Formulae (a1) and (a2) are expressed as follows:

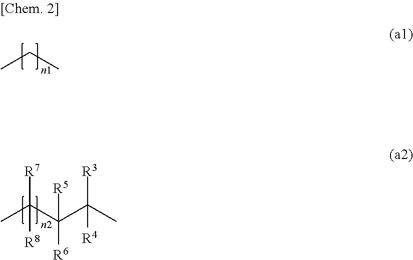

In Formula (a1), n1 denotes an integer of 2 or more. In Formula (a2), R³, R⁴, R⁷, and R⁸ are the same as or different from one another and each represent a hydrogen atom or an alkyl group; R⁵ and R⁶ are the same as or different from each other and each represent an alkyl group; and n2 denotes an integer of 0 or more. When n2 is an integer of 2 or more, two or more R⁷s may be the same as or different from one another, and two or more R⁸s may be the same as or different from one another.

The repetition number n1 in Formula (a1) denotes an integer of 2 or more and is preferably an integer of from 2 to 20 and particularly preferably an integer of from 2 to 10. A compound in which n1 is 1 may give an insufficiently flexible cured article through polymerization.

The alkyl groups as R³, R⁴, R⁵, R⁶, R⁷, and R⁸ in Formula (a2) are preferably, but not limitatively, alkyl groups having 1 to 4 carbon atoms, which are exemplified by linear alkyl groups having 1 to 4 carbon atoms, such as methyl group, ethyl group, propyl group, and butyl group, of which those having 1 to 3 carbon atoms are more preferred; and branched chain alkyl groups having 1 to 4 carbon atoms, such as isopropyl group, isobutyl group, s-butyl group, and t-butyl group, of which those having 1 to 3 carbon atoms are more preferred. R³ and R⁴ are preferably hydrogen atoms; and R⁵ and R⁶ are preferably methyl group and/or ethyl group.

The repetition number n2 in Formula (a2) denotes an integer of 0 or more and is preferably an integer of from 1 to 20 and particularly preferably an integer of from 1 to 10.

Typical examples of the oxetane-ring-containing (meth)acrylic ester compound represented by Formula (1) include compounds as follows:

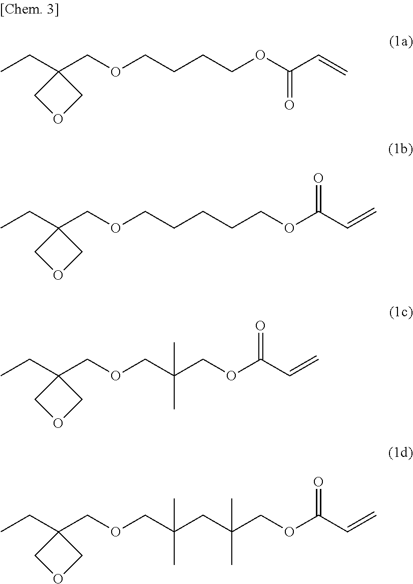

The oxetane-ring-containing (meth)acrylic ester compound represented by Formula (1) may be synthetically prepared typically by allowing a compound represented by following Formula (2):

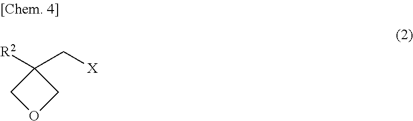

wherein R² is as defined above; and X represents a leaving group,
to react with a compound represented by following Formula (3):

[Chem. 5]

HO-A-OH (3)

wherein “A” is as defined above,
in the presence of a basic substance in a single-liquid phase system to give an oxetane-ring-containing alcohol represented by following Formula (4):

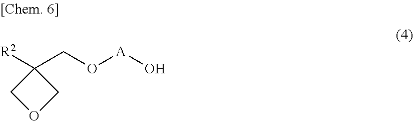

wherein R² and “A” are as defined above; and (meth)acrylating the oxetane-ring-containing alcohol.

In Formula (2), X represents a leaving group. The leaving group is exemplified by groups having high leaving ability, including halogen atoms such as chlorine, bromine, and iodine atoms, of which bromine atom and iodine atom are preferred; sulfonyloxy groups such as p-toluenesulfonyloxy group, methanesulfonyloxy group, and trifluoromethanesulfonyloxy group; and carbonyloxy groups such as acetyloxy group.

The basic substance is exemplified by alkali metal or alkaline earth metal hydroxides such as sodium hydroxide, potassium hydroxide, calcium hydroxide, and magnesium hydroxide; alkali metal or alkaline earth metal hydrides such as sodium hydride, magnesium hydride, and calcium hydride; alkali metal or alkaline earth metal carbonates such as sodium carbonate, sodium hydrogencarbonate, potassium carbonate, and potassium hydrogencarbonate; and organometallic compounds such as organic lithium reagents (e.g., methyllithium, ethyllithium, n-butyllithium, s-butyllithium, and t-butyllithium) and organic magnesium reagents (Grignard reagents; such as MeMgBr and EtMgBr). Each of them may be used alone or in combination.

As used herein the term “single-liquid phase system” refers to a system including a liquid phase in a number of not two or more but only one. The system may further include a solid, as long as including only one liquid phase. A solvent for use herein may be any one that can solve both the compound represented by. Formula (2) and the compound represented by Formula (3) therein. Such solvent is exemplified by aromatic hydrocarbons such as benzene, toluene, xylenes, and ethylbenzene; ethers such as THF (tetrahydrofuran) and IPE (isopropyl ether); sulfur-containing solvents such as DMSO (dimethyl sulfoxide); and nitrogen-containing solvents such as DMF (dimethylformamide).

Cationically Polymerizable Resin

The cationically polymerizable resin is obtained by subjecting the oxetane-ring-containing (meth)acrylic ester compound represented by Formula (1) to radical polymerization alone or in combination with another radically polymerizable compound. The term “other radically polymerizable compound” refers to a compound which is radically polymerizable and is other than the oxetane-ring-containing (meth)acrylic ester compounds represented by Formula (1). This compound is hereinafter also referred to as an “other radically polymerizable compound”.

The oxetane-ring-containing (meth)acrylic ester compound represented by Formula (1) has an oxetane ring serving as a cationically polymerizable moiety and a (meth)acryloyl group serving as a radically polymerizable moiety per molecule. The compound therefore synthetically gives a cationically polymerizable resin represented by a formula by subjecting the compound alone to radical polymerization or subjecting the compound to radical copolymerization in combination with the other radically polymerizable compound. The “radical copolymerization” includes, but is not limited to, block copolymerization and random copolymerization. The formula is expressed as follows:

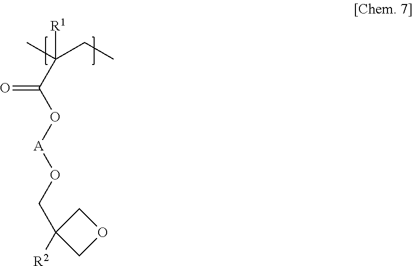

wherein R¹, R², and “A” are as defined above.

Of such cationically polymerizable resins, preferred is a resin obtained through radical polymerization of the oxetane-ring-containing (meth)acrylic ester compound represented by Formula (1) in combination with the other radically polymerizable compound. This is preferred for the formation of a more flexible cured article. Specifically, preferred is a cationically polymerizable resin obtained through radical copolymerization so that entire monomers constituting the cationically polymerizable resin include a monomer derived from the oxetane-ring-containing (meth)acrylic ester compound represented by Formula (1) in a content of from 0.1 percent by weight to less than 100 percent by weight, more preferably from 1 to 99 percent by weight, furthermore preferably from 10 to 80 percent by weight, and particularly preferably from 10 to 50 percent by weight, based on the total weight of the entire monomers.

The other radically polymerizable compound is exemplified by compounds having at least one radically polymerizable group per molecule. The radically polymerizable group is exemplified by (meth)acryloyl group, (meth)acryloyloxy group, (meth)acryloylamino group, vinyl ether group, a vinylaryl group, and vinyloxycarbonyl group.

Exemplary compounds having at least one (meth)acryloyl group per molecule include 1-buten-3-one, 1-penten-3-one, 1-hexen-3-one, 4-phenyl-1-buten-3-one, and 5-phenyl-1-penten-3-one; and derivatives of them.

Exemplary compounds having at least one (meth)acryloyloxy group per molecule include methyl (meth)acrylate, ethyl (meth)acrylate, n-butyl (meth)acrylate, isobutyl (meth)acrylate, t-butyl methacrylate, n-hexyl (meth)acrylate, 2-ethylhexyl (meth)acrylate, isodecyl (meth)acrylate, n-lauryl (meth)acrylate, n-stearyl (meth)acrylate, n-butoxyethyl (meth)acrylate, butoxydiethylene glycol (meth)acrylate, methoxytriethylene glycol (meth)acrylate, methoxypolyethylene glycol (meth)acrylates, cyclohexyl (meth)acrylate, tetrahydrofurfuryl (meth)acrylate, benzyl (meth)acrylate, phenoxyethyl (meth)acrylate, isobornyl (meth)acrylate, 2-hydroxyethyl (meth)acrylate, 2-hydroxypropyl (meth)acrylate, 2-hydroxybutyl (meth)acrylate, dimethylaminoethyl (meth)acrylate, diethylaminoethyl (meth)acrylate, methacrylic acid, 2-methacryloyloxyethyl succinate, 2-methacryloyloxyethyl hexahydrophthalate, 2-methacryloyloxyethyl-2-hydroxypropyl phthalate, glycidyl (meth)acrylate, 2-methacryloyloxyethyl acid phosphate, ethylene glycol di(meth)acrylate, diethylene glycol di(meth)acrylate, triethylene glycol di(meth)acrylate, 1,4-butanediol di(meth)acrylate, neopentyl glycol di(meth)acrylate, 1,6-hexanediol di(meth)acrylate, 1,9-nonanediol di(meth)acrylate, 1,10-decanediol di(meth)acrylate, decane di(meth)acrylate, glycerol di(meth)acrylate, 2-hydroxy-3-acryloyloxypropyl (meth)acrylate, dimethyloltricyclodecane di(meth)acrylate, trifluoroethyl (meth)acrylate, perfluorooctylethyl (meth)acrylate, isoamyl (meth)acrylate, isomyristyl (meth)acrylate, γ-(meth)acryloxypropyltrimethoxysilane, 2-(meth)acryloyloxyethyl isocyanate, 1,1-bis(acryloyloxy)ethyl isocyanate, 2-(2-methacryloyloxyethyloxy)ethyl isocyanate, vinyltrimethoxysilane, vinyltriethoxysilane, and 3-(meth)acryloxypropyltriethoxysilane; and derivatives of them.

Exemplary compounds having at least one (meth)acryloylamino group per molecule include morpholin-4-yl acrylate, acryloylmorpholine, N,N-dimethylacrylamide, N,N-diethylacrylamide, N-methylacrylamide, N-ethylacrylamide, N-propylacrylamide, N-isopropylacrylamide, N-butylacrylamide, N-n-butoxymethylacrylamide, N-hexylacrylamide, and N-octylacrylamide; and derivatives of them.

Exemplary compounds having at least one vinyl ether group per molecule include 2-hydroxyethyl vinyl ether, 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,4-cyclohexanedimethanol monovinyl ether, 1,3-cyclohexanedimethanol monovinyl ether, 1,2-cyclohexanedimethanol monovinyl ether, p-xylene glycol monovinyl ether, m-xylene glycol monovinyl ether, o-xylene glycol monovinyl ether, diethylene glycol monovinyl ether, triethylene glycol monovinyl ether, tetraethylene glycol monovinyl ether, pentaethylene glycol monovinyl ether, oligoethylene glycol monovinyl ethers, polyethylene glycol monovinyl ethers, dipropylene glycol monovinyl ether, tripropylene glycol monovinyl ether, tetrapropylene glycol monovinyl ether, pentapropylene glycol monovinyl ether, oligopropylene glycol monovinyl ethers, and polypropylene glycol monovinyl ethers; and derivatives of them.

Exemplary compounds having at least one vinylaryl group per molecule include styrene, divinylbenzenes, methoxystyrenes, ethoxystyrenes, hydroxystyrenes, vinylnaphthalenes, vinylanthracenes, 4-vinylphenyl acetate, (4-vinylphenyl)dihydroxyborane, (4-vinylphenyl)boranic acid, (4-vinylphenyl)boronic acid, 4-ethenylphenylboronic acid, 4-vinylphenylboranic acid, 4-vinylphenylboronic acid, p-vinylphenylboric acid, p-vinylphenylboronic acid, N-(4-vinylphenyl)maleimide, N-(p-vinylphenyl)maleimide, and N-(p-vinylphenyl)maleimide; and derivatives of them.

Exemplary compounds having at least one vinyloxycarbonyl group per molecule include isopropenyl formate, isopropenyl acetate, isopropenyl propionate, isopropenyl butyrate, isopropenyl isobutyrate, isopropenyl caproate, isopropenyl valerate, isopropenyl isovalerate, isopropenyl lactate, vinyl acetate, vinyl propionate, vinyl butyrate, vinyl caproate, vinyl caprylate, vinyl laurate, vinyl myristate, vinyl palmitate, vinyl stearate, vinyl cyclohexanecarboxylate, vinyl pivalate, vinyl octanoate, vinyl monochloroacetate, divinyl adipate, vinyl methacrylate, vinyl crotonate, vinyl sorbate, vinyl benzoate, and vinyl cinnamate; and derivatives of them.

Of the other radically polymerizable compounds, preferred are compounds having, per molecule, only one functional group selected from the group consisting of (meth)acryloyl group, (meth)acryloyloxy group, (meth)acryloylamino group, a vinylaryl group, vinyl ether group, and vinyloxycarbonyl group. These compounds are preferred for the formation of an optical fiber having flexibility and thermal stability at satisfactory levels. Among them, particularly preferred are compounds having only one (meth)acryloyloxy group per molecule, such as n-butyl (meth)acrylate, isobutyl (meth)acrylate, t-butyl methacrylate, n-hexyl (meth)acrylate, and 2-ethylhexyl (meth)acrylate. Each of them may be used alone or in combination.

The radical polymerization reaction can be accelerated through the application of heat (heating treatment) and/or light (light irradiation). The heating treatment may be performed at a temperature suitably adjustable according typically to types of components and a catalyst for use in the reaction and is performed at a temperature of typically preferably from about 20° C. to about 200° C., more preferably from about 50° C. to about 150° C., and furthermore preferably from about 70° C. to about 120° C. The light irradiation may employ, as a light source, any of mercury lamps, xenon lamps, carbon arc lamps, metal halide lamps, sunlight, electron beams, and laser beams. After the light irradiation, a heating treatment at a temperature typically of from about 50° C. to about 180° C. may be performed so as to further proceed the radical polymerization reaction.

The radical polymerization reaction is generally performed in the presence of a solvent. The solvent is exemplified by 1-methoxy-2-acetoxypropane (PGMEA), benzene, and toluene.

The radical polymerization reaction may employ a polymerization initiator. The polymerization initiator is not limited, as long as capable of inducing radical polymerization, and is exemplified by known or customary thermal initiators and photo-radical polymerization initiators. These are exemplified by benzoyl peroxide, azobisisobutyronitrile (AIBN), azobis-2,4-dimethylvaleronitrile, and 2,2′-azobis(isobutyric acid)dimethyl.

The polymerization initiator in the radical polymerization reaction may be used in an amount of not critical, but typically preferably from 0.01 to 50 parts by weight and more preferably from 0.1 to 20 parts by weight, per 100 parts by weight of total weight of radically polymerizable compounds (total weight of the oxetane-ring-containing (meth)acrylic ester compound represented by Formula (1) and the other radically polymerizable compound).

Though not critical, the cationically polymerizable resin has a weight-average molecular weight of preferably 500 or more (e.g., from 500 to 1000000) and more preferably from 3000 to 500000. A cationically polymerizable resin having a weight-average molecular weight out of this range may readily impede the formation of an optical fiber having sufficient flexibility through curing of the cationically polymerizable resin composition.

Though not critical, the cationically polymerizable resin has a number-average molecular weight of preferably 100 or more (e.g., from 100 to 500000) and more preferably from 300 to 250000. A cationically polymerizable resin having a number-average molecular weight out of this range may readily impede the formation of an optical fiber having sufficient flexibility through curing of the cationically polymerizable resin composition. The weight-average molecular weight and the number-average molecular weight of the cationically polymerizable resin can be measured typically by gel permeation chromatography (GPC) in terms of a polystyrene standard.

Cationically Polymerizable Resin Composition

The cationically polymerizable resin composition includes the cationically polymerizable resin as an essential component. Though not critical, the cationically polymerizable resin composition may include the cationically polymerizable resin in a proportion (content) of preferably 5 percent by weight or more and may substantially exclusively include the cationically polymerizable resin. For the formation of an optical fiber having further satisfactory flexibility, the composition may include the cationically polymerizable resin in a content of preferably from 10 to 95 percent by weight and more preferably from 40 to 95 percent by weight. A composition including the cationically polymerizable resin in a content of less than 5 percent by weight may readily give, through curing by cationic polymerization, an optical fiber having insufficient flexibility.

The cationically polymerizable resin composition may further contain, in addition to the cationically polymerizable resin, a cationically polymerizable compound other than the oxetane-ring-containing (meth)acrylic ester compound represented by Formula (1). The compound in question is hereinafter also referred to as an “other cationically polymerizable compound”.

The other cationically polymerizable compound is exemplified by compounds having at least one cationically polymerizable group per molecule. The cationically polymerizable group is exemplified by oxetane ring, epoxy ring, vinyl ether group, and a vinylaryl group.

Exemplary compounds having at least one oxetane ring per molecule include 3,3-bis(vinyloxymethyl)oxetane, 3-ethyl-3-hydroxymethyloxetane, 3-ethyl-3-(2-ethylhexyloxymethyl)oxetane, 3-ethyl-3-(hydroxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis{[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, 1,4-bis{[(3-ethyl-3-oxetanyl)methoxy]methyl}benzene, and 3-ethyl-3{[(3-ethyloxetan-3-yl)methoxy]methyl}oxetane.

Exemplary compounds having at least one epoxy ring per molecule include bisphenol-A diglycidyl ether, bisphenol-F diglycidyl ether, bisphenol-S diglycidyl ether, brominated bisphenol-A diglycidyl ethers, brominated bisphenol-F diglycidyl ethers, brominated bisphenol-S diglycidyl ethers, epoxy novolak resins, hydrogenated bisphenol-A diglycidyl ether, hydrogenated bisphenol-F diglycidyl ether, hydrogenated bisphenol-S diglycidyl ether, 3,4-epoxycyclohexylmethyl 3′,4′-epoxycyclohexanecarboxylate, 2-(3,4-epoxycyclohexyl-5,5-spiro-3,4-epoxy)cyclohexane-m-dioxane, bis(3,4-epoxycyclohexylmethyl)adipate, bis(3,4-epoxy-6-methylcyclohexylmethyl)adipate, 3,4-epoxy-6-methylcyclohexyl 3′,4′-epoxy-6′-methylcyclohexanecarboxylate, methylenebis(3,4-epoxycyclohexane), dicyclopentadiene diepoxide, ethylene glycol di(3,4-epoxycyclohexylmethyl) ether, ethylene-bis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ethers, and polypropylene glycol diglycidyl ethers; polyglycidyl ethers of polyetherpolyols which are obtained by adding at least one alkylene oxide to an aliphatic polyhydric alcohol (e.g., ethylene glycol, propylene glycol, or glycerol); diglycidyl esters of aliphatic long-chain dibasic acids; monoglycidyl ethers of aliphatic higher alcohols; monoglycidyl ethers of phenol, cresol, butylphenol, or a polyether alcohol obtained by adding an alkylene oxide to any of these alcohols; and glycidyl esters of higher fatty acids.

Exemplary compounds having at least one vinyl ether group per molecule and exemplary compounds having at least one vinylaryl group per molecule include those exemplified as the other radically polymerizable compound.

Of the other cationically polymerizable compounds, preferred are compounds having at least one oxetane ring per molecule, such as 3-ethyl-3-(2-ethylhexyloxymethyl)oxetane, 3,3-bis(vinyloxymethyl)oxetane, 1,4-bis{[(3-ethyl-3-oxetanyl)methoxy]methyl}benzene, and 3-ethyl-3-{[(3-ethyloxetan-3-yl)methoxy]methyl}oxetane. These compounds are rapidly cured by light irradiation. Each of them may be used alone or in combination.

For the formation of an optical fiber having further satisfactory flexibility, the cationically polymerizable resin composition preferably further includes another cationically polymerizable compound in combination with the cationically polymerizable resin. Though not critical, the compositional ratio (weight ratio) of the cationically polymerizable resin to the other cationically polymerizable compound is preferably from 95:5 to 10:90, more preferably from 95:5 to 20:80, and furthermore preferably from 95:5 to 45:55. If the blending ratio (compositional ratio) of the cationically polymerizable resin is less than the range, the resulting optical fiber may readily have insufficient flexibility.

The cationically polymerizable resin composition may contain a polymerization initiator according to necessity. The polymerization initiator can be any one selected from known or customary photo-cationic polymerization initiators, photoacid generators (light-activatable acid generators), and other initiators that can induce cationic polymerization. The polymerization initiator is exemplified by sulfonium salts such as triarylsulfonium hexafluorophosphate and triarylsulfonium hexafluoroantimonates; iodonium salts such as diaryliodonium hexafluorophosphates, diphenyliodonium hexafluoroantimonate, bis(dodecylphenyl)iodonium tetrakis(pentafluorophenyl)borate, and iodonium [4-(4-methylphenyl-2-methylpropyl)phenyl]hexafluorophosphate; phosphonium salts such as tetrafluorophosphonium hexafluorophosphate; and Pyridium salts.

The photoacid generators for use herein may also be a commercial product such as one available under the trade name “CPI-100P” (from San-Apro Ltd.).

The polymerization initiator may be used in the cationic polymerization reaction in an amount of preferably from 0.01 to 50 parts by weight and more preferably from 0.1 to 20 parts by weight, per 100 parts by weight of the total weight of entire cationically polymerizable compounds (total weight of the cationically polymerizable resin and the other cationically polymerizable compound).

The cationically polymerizable resin composition may further contain any of other additives according to necessity, within ranges not adversely affecting advantageous effects of the present invention. The other additives are exemplified by setting-expandable monomers, photosensitizers (e.g., anthracene sensitizers), resins, adhesion promoters, reinforcers, softeners, plasticizers, viscosity modifiers, solvents, inorganic or organic particles (e.g., nano-scale particles), fluorosilanes, and other known or customary additives.

The photocurable composition(s) as a material for the optical fiber according to the present invention can also be, instead of the cationically polymerizable resin composition(s), a photocurable resin composition(s) (radically polymerizable resin composition(s)) which includes a radically polymerizable resin as an essential component. The radically polymerizable resin is obtained by subjecting the oxetane-ring-containing (meth)acrylic ester compound represented by Formula (1) to cationic polymerization alone or in combination with cationically polymerizable another compound (other cationically polymerizable compound), as described above. When the radically polymerizable resin composition is used, light irradiation should be performed in an atmosphere of a gas inert to radicals (e.g., nitrogen gas atmosphere) to prevent inhibition on the curing reaction.

Radically Polymerizable Resin

The radically polymerizable resin is obtained by subjecting the oxetane-ring-containing (meth)acrylic ester compound represented by Formula (1) to cationic polymerization alone or in combination with cationically polymerizable another compound (other cationically polymerizable compound).

The oxetane-ring-containing (meth)acrylic ester compound represented by Formula (1) has both an oxetane ring serving as a cationically polymerizable moiety and a (meth)acryloyl group serving as a radically polymerizable moiety per molecule. This compound, when subjected alone to cationic polymerization, or subjected to cationic copolymerization in combination with another cationically polymerizable compound, can synthetically gives a radically polymerizable resin represented by a formula. The term “cationic copolymerization” includes block copolymerization and random copolymerization. The formula is expressed as follows:

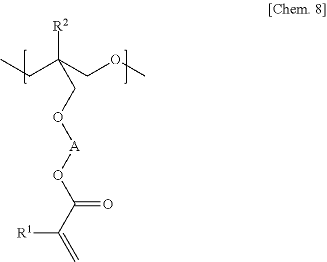

wherein R¹, R², and “A” are as defined above.

Of such radically polymerizable resins, preferred are radically polymerizable resins obtained by subjecting the oxetane-ring-containing (meth)acrylic ester compound represented by Formula (1) and the other cationically polymerizable compound to cationic copolymerization. These resins can form a cured article (optical fiber) having further satisfactory flexibility. Among them, particularly preferred are resins obtained by subjecting the components to cationic copolymerization so that entire monomers constituting the radically polymerizable resin include a monomer derived from the oxetane-ring-containing (meth)acrylic ester compound represented by Formula (1) in a content of 0.1 percent by weight or more, preferably from 1 to 99 percent by weight, and particularly preferably from 10 to 80 percent by weight.

The other cationically polymerizable compound is exemplified by the compounds having at least one cationically polymerizable group (e.g., oxetane ring, epoxy ring, vinyl ether group, or a vinylaryl group) per molecule, as exemplified in the description of the cationically polymerizable resin composition.

Of the other cationically polymerizable compounds, preferred are compounds having only one functional group selected from the group consisting of oxetane ring, epoxy ring, vinyl ether group, and a vinylaryl group per molecule. These compounds contribute to the formation of a cured article having flexibility and thermal stability at satisfactory levels. Among them, particularly preferred are compounds having only one oxetane ring per molecule, such as trimethylene oxide, 3-ethyl-3-(2-ethylhexyloxymethyl)oxetane, 3-ethyl-3-[(phenoxy)methyl]oxetane, and 3-ethyl-3-(hexyloxymethyl)oxetane; and compounds having only one epoxy group per molecule, such as glycidyl methyl ether and (R)-glycidyl butyrate. Each of them may be used alone or in combination.

The cationic polymerization reaction is generally performed in the presence of a solvent. The solvent is exemplified by benzene, toluene, and xylenes.

The cationic polymerization reaction may employ a polymerization initiator. The polymerization initiator is exemplified by the cationic polymerization initiators and acid generators exemplified in the description of the cationically polymerizable resin composition.

The polymerization initiator may be used in the cationic polymerization reaction in an amount of typically preferably from 0.01 to 50 parts by weight and more preferably from 0.1 to 20 parts by weight, per 100 parts by weight of the total weight of entire cationically polymerizable compounds (total weight of the oxetane-ring-containing (meth)acrylic ester compound represented by Formula (1) and the other cationically polymerizable compound).

The cationic polymerization reaction may be performed in the presence of a polymerization inhibitor. The polymerization inhibitor is exemplified by quinone/phenol inhibitors such as 4-methoxyphenol, hydroquinone, methylhydroquinone, dimethylhydroquinone, trimethylhydroquinone, hydroquinone monomethyl ether, 2,5-di-t-butylhydroquinone, p-t-butylcatechol, mono-t-butylhydroquinone, p-benzoquinone, naphthoquinone, 2,5-di-t-butyl-p-cresol, α-naphthol, and nitrophenol; thioether inhibitors; and phosphorous ester (phosphite) inhibitors.

Though not critical, the radically polymerizable resin has a weight-average molecular weight of preferably 500 or more (e.g., from about 500 to about 1000000) and more preferably from 3000 to 500000. A radically polymerizable resin having a weight-average molecular weight of less than the range may give, through radical polymerization, a cured article (optical fiber) having insufficient flexibility. The weight-average molecular weight of the radically polymerizable resin can be measured typically by gel permeation chromatography (GPC) in terms of a polystyrene standard.

Radically Polymerizable Resin Composition

The radically polymerizable resin composition includes the radically polymerizable resin as an essential component. Though not critical, the radically polymerizable resin composition may include the radically polymerizable resin in a proportion (content) of preferably 5 percent by weight or more and may substantially exclusively include the radically polymerizable resin. The composition may include the radically polymerizable resin in a content of preferably 10 percent by weight or more and more preferably from 60 to 90 percent by weight. This range is preferred for the formation of an optical fiber having more satisfactory flexibility. A composition including the radically polymerizable resin in a content of less than 5 percent by weight may readily give, through curing by cationic polymerization, an optical fiber having insufficient flexibility.

The radically polymerizable resin composition may further contain, in addition to the radically polymerizable resin, a radically polymerizable compound other than the oxetane-ring-containing (meth)acrylic ester compound represented by Formula (1) (other radically polymerizable compound).

The other radically polymerizable compound is exemplified by the compounds having at least one radically polymerizable group per molecule as exemplified in the description of the cationically polymerizable resin. The radically polymerizable group is typified by (meth)acryloyl group, (meth)acryloyloxy group, (meth)acryloylamino group, a vinylaryl group, vinyl ether group, and vinyloxycarbonyl group.

Of the other radically polymerizable compounds, preferred are compounds having two or more (particularly preferably two) (meth)acryloyloxy groups, such as ethylene glycol di(meth)acrylate, diethylene glycol di(meth)acrylate, triethylene glycol di(meth)acrylate, 1,4-butanediol di(meth)acrylate, neopentyl glycol di(meth)acrylate, 1,6-hexanediol di(meth)acrylate, 1,9-nonanediol di(meth)acrylate, 1,10-decanediol di(meth)acrylate, decane di(meth)acrylate, and glycerol di(meth)acrylate. These compounds contribute to the formation of a cured article having more satisfactory thermal stability. Each of them may be used alone or in combination.

The radically polymerizable resin composition preferably includes another radically polymerizable compound in addition to the radically polymerizable resin so as to form an optical fiber having more satisfactory thermal stability. The compositional ratio (in weight ratio) of the radically polymerizable resin to the other radically polymerizable compound is typically preferably from 95:5 to 5:95, more preferably from 95:5 to 20:80, and furthermore preferably from 95:5 to 60:40. The radically polymerizable resin, if contained in a blending ratio out of the range, may readily give an optical fiber having insufficient flexibility.

The radically polymerizable resin composition may further include a polymerization initiator, or not. The polymerization initiator can be any one selected from known or customary photo-radical polymerization initiators and other initiators that can induce radical polymerization.

The photo-radical polymerization initiators are exemplified by benzophenone, acetophenone benzyl, benzyl dimethyl ketone, benzoin, benzoin methyl ether, benzoin ethyl ether, benzoin isopropyl ether, dimethoxyacetophenone, dimethoxyphenylacetophenone, diethoxyacetophenone, and diphenyl disulfite. Each of them may be used alone or in combination.

The polymerization initiator may be used in combination with a synergistic agent to enhance the conversion of adsorbed light energy to polymerization-initiating free radicals. The synergistic agent is exemplified by amines such as triethylamine, diethylamine, diethanolamine, ethanolamine, dimethylaminobenzoic acid, and methyl dimethylaminobenzoate; and ketones such as thioxanthone, 2-isopropylthioxanthone, 2,4-diethylthioxanthone, and acetylacetone.

The polymerization initiator, when added to the radically polymerizable resin composition, may be used in an amount of preferably from 0.01 to 50 parts by weight and more preferably from 0.1 to 20 parts by weight, per 100 parts by weight of entire radically polymerizable compounds (total weight of the radically polymerizable resin and the other radically polymerizable compound) in the radically polymerizable resin composition.

The radically polymerizable resin composition may further contain one or more other additives according to necessity, within ranges not adversely affecting advantageous effects of the present invention. The other additives are exemplified by setting-expandable monomers, photosensitizers (e.g., anthracene sensitizers), resins, adhesion promoters, reinforcers, softeners, plasticizers, viscosity modifiers, solvents, inorganic or organic particles (e.g., nano-scale particles), fluorosilanes, and other known or customary additives.

The optical fiber according to the present invention, when being an optical fiber having a core-cladding structure, may have a diameter of the core (core diameter) of preferably, but not limitatively, from 10 to 999 μm and more preferably from 50 to 100 μm; and may have a diameter of the cladding (cladding diameter) of preferably, but not limitatively, from 60 to 1000 μm and more preferably from 100 to 500 μm.

Upon usage, a suitable covering layer (coating layer) may be provided outside of the cladding of the optical fiber according to the present invention. The covering layer is exemplified by covering layers made typically from any of polyimides, polypropylenes, polyethylenes, PTFEs, and poly(vinyl chloride)s.

The optical fiber according to the present invention may be produced by the optical-fiber production method according to the present invention. The optical fiber according to the present invention therefore has a uniform diameter and excels in quality. The optical fiber can be produced with good productivity and also excels in cost. The optical fiber employs a photocurable composition that is liquid at room temperature as a material. This facilitates the removal of impurities from the photocurable composition by filtration and enables easy formation of a high-quality optical fiber.

The optical fiber according to the present invention, when produced while using the double-tube nozzle as the nozzle for discharging photocurable compositions, can have a core and a cladding being accurately concentric with each other. The optical fiber can therefore exhibit satisfactory reliability upon connection to another piece of the optical fiber or to another device. The optical fiber according to the present invention, when produced so that the light irradiation angle satisfies the condition specified by Expression (I), can have a further uniform diameter and can be produced with further satisfactory productivity.

The optical fiber according to the present invention is widely usable typically for optical communications or for ornamental purposes. The optical fiber excels particularly in thermal stability and flexibility and is advantageously usable typically for communications in portable equipment, factory automation equipment, office automation equipment, audio equipment, vehicles, and LANs; image transmission typically in household or industrial endoscopes; sensors; optical transmission typically in inspection/measurement lighting and art works lighting; and ornamental purposes typically in billboards, signs, and aspect lighting.

### EXAMPLES

The present invention will be illustrated in further detail with reference to several examples below, which are by no means intended to limit the scope of the invention.

Production Example of Core-Forming Photocurable Composition (Core Composition)

In a five-necked flask equipped with a monomer-dropping line, an initiator-dropping line, a thermometer, a reflux condenser, and agitator blades were placed 25% of a mixture (monomer mixture). The monomer mixture contained 62.07 g of PGMEA, 10.13 g (0.039 mol) of 3-ethyl-3-(3-acryloyloxy-2,2-dimethylpropyloxymethyl)oxetane (EOXTM-NPAL) represented by the following formula, and 27.06 g (0.195 mol) of BA. The mixture was heated to 85±1° C. in a nitrogen stream. Next, a mixture of 0.07 g of t-butyl peroxypivalate (PERBUTYL PV: supplied by NOF Corporation) and 1.08 g of PGMEA was charged, stirred to give a uniform mixture, and, to the resulting mixture with stirring, the remaining 75% of the monomer mixture and a mixture of 0.63 g of AIBN and 6.47 g of PGMEA were added dropwise over 3 hours using delivery pumps. Immediately after the completion of dropwise addition, a mixture of 0.21 g of AIBN and 2.16 g of PGMEA was charged and, one hour later, a mixture of 0.21 g of AIBN and 2.21 g of PGMEA was charged. The resulting mixture was held for further 2 hours, cooled down to 40° C. or lower, and yielded a resin composition. This was purified through reprecipitation from a five-fold amount of a 60 percent by weight methanol aqueous solution, held in a vacuum dryer (40° C., full vacuum) for 60 hours, and yielded a colorless, transparent core prepolymer (liquid resin).

The core prepolymer had a weight-average molecular weight of 67600 and a number-average molecular weight of 11800 each in terms of a polystyrene standard.

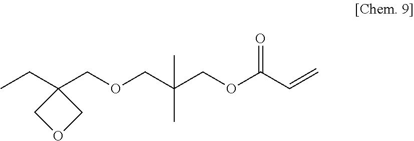 [SMILES: C=CC(=O)OCC(C)(C)COCC1(CC)COC1]

To 60 percent by weight of the core prepolymer were added 15 percent by weight of a product under the trade name “OXT-212” (supplied by Toagosei Co., Ltd.) and 25 percent by weight of a product under the trade name “OXT-DVE” to give a mixture. An initiator under the trade name “CPI-100P” (supplied by San-Apro Ltd.) was added to and mixed with the mixture in an amount of 3 parts by weight per 100 parts by weight of the mixture and yielded a core-forming photocurable composition (photocurable resin composition) (core composition). This had a viscosity at 25° C. of 15000 cP.

The product “OXT-212” is 3-ethyl-3-(2-ethylhexyloxymethyl)oxetane.

The product “OXT-DVE” is 3,3-bis(vinyloxymethyl)oxetane.

The product “CPI-100P” is a mixture of diphenyl[4-(phenylthio)phenyl]sulfonium hexafluorophosphate, (thiodi-p-phenylene)bis(diphenylsulfonium) bis(hexafluorophosphate), propylene carbonate, and diphenyl sulfide.

Production Example of Cladding-Forming Photocurable Composition (Cladding Composition)

In a five-necked flask equipped with a monomer-dropping line, an initiator-dropping line, a thermometer, a reflux condenser, and agitator blades was placed 24.93 g of PGMEA, followed by heating to 75±1° C. in a nitrogen stream. Next, a mixture was added dropwise with stirring over 5 hours using a delivery pump. The mixture contained 43.64 g of PGMEA, 20.08 g (0.078 mol) of EOXTM-NPAL, 50.59 g (0.39 mol) of BA, and 0.043 g of dimethyl 2,2′-azobis(2-methylpropionate) (V-601). After the completion of dropwise addition, the resulting mixture was held for further 2 hours, cooled down to 40° C. or lower, and yielded a resin composition. This was diluted with 140.04 g of PGMEA, purified through reprecipitation from a five-fold amount of a 60 percent by weight methanol aqueous solution, held in a vacuum dryer (40° C., full vacuum) for 60 hours, and yielded a colorless, transparent cladding prepolymer (liquid resin).

The cladding prepolymer had a weight-average molecular weight of 288000 and a number-average molecular weight of 61200 each in terms of a polystyrene standard.

To 63 percent by weight of the cladding prepolymer was added 37 percent by weight of “OXT-DVE” to give a mixture. This mixture (100 parts by weight) was combined and mixed with 5 parts by weight of a product under the trade name “CELLOXIDE 8000” and 1 part by weight of an initiator as a product under the trade name “CPI-100P” (supplied by San-Apro Ltd.) and yielded a cladding-forming photocurable composition (photocurable resin composition) as a cladding composition having a viscosity of 70000 cP at 25° C.

The product “CELLOXIDE 8000” is 3,4,3′,4′-diepoxybicyclohexyl.

### Example 1

### Optical-Fiber Production Apparatus

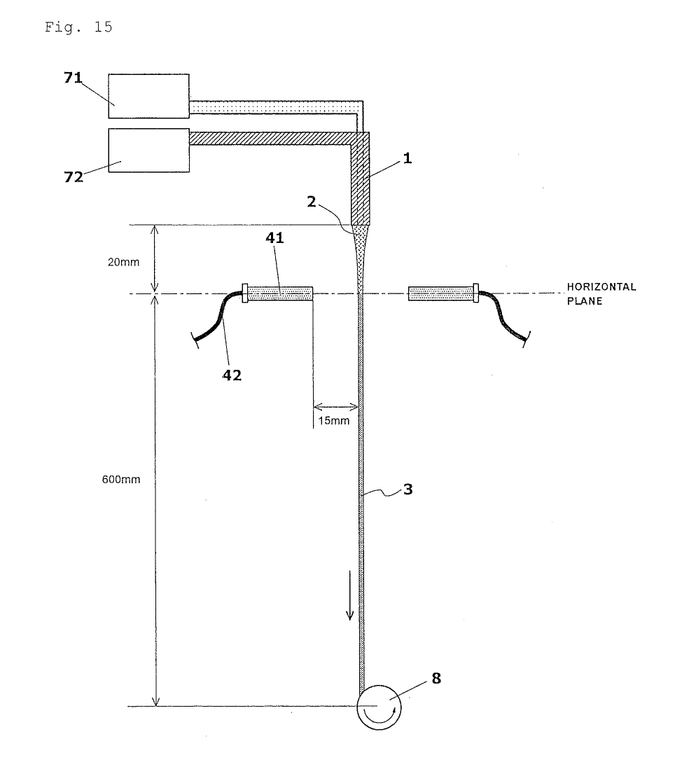

The production apparatus illustrated in FIG. 14 was used as an optical-fiber production apparatus. In the optical-fiber production apparatus illustrated in FIG. 14, reference sign 1 stands for a double-tube nozzle. The double-tube nozzle 1 had an outer tube and an inner tube each having an inner diameter as follows. The optical-fiber production apparatus illustrated in FIG. 14 employed, as a light irradiator, the light irradiator illustrated in FIG. 5. This light irradiator was capable of applying light to photocurable compositions 2 from three directions. The light irradiator included three light guides (UV light guides) whose tips were arranged at the same height equidistantly from the photocurable composition 2. The tips were arranged at regular intervals from one another (at intervals of 120° from one another around the photocurable composition) (see FIG. 5). The light irradiator employed a light source “SPOTCURE SP9-250DB” (supplied by Ushio Inc.). FIG. 14 illustrates only two light guide tips for convenience.

Light-shielding tubes 51 were arranged around the light guide tips 41, respectively; and a light-shielding plate 52 was arranged between the output terminals of the light guide tips 41 and the orifice of the double-tube nozzle 1.

As illustrated in FIG. 14, the light guide tips 41 were arranged below the orifice of the double-tube nozzle 1 so that a height (vertical dimension) from the orifice of the double-tube nozzle 1 to the output terminal (central part of the output terminal) of each light guide tip 41 be 20 mm and that the distance between the output terminals (central part of the output terminal) of the light guide tips 41 and the photocurable compositions 2 be 15 mm.

The light guide tips 41 were arranged so as to tilt at 11° downward with respect to the horizontal plane. The divergence angle ψ of light was 22°, which light was emitted from the light guide tips 41 around which the light-shielding tubes 51 were placed.

Optical Fiber Production

Initially, the core composition and the cladding composition were fed at feed rates as follows using metering pumps 71 and 72 and simultaneously discharged vertically downward from the orifice of the double-tube nozzle 1. In the double-tube nozzle 1, the core composition was fed through the inner tube, whereas the cladding composition was fed through space between the outer tube and the inner tube.

Next, the light irradiator applied ultraviolet rays to the core composition and the cladding composition to cure the compositions to give an optical fiber. The produced optical fiber (plastic optical fiber) was collected by a winder 8.

Experimental Conditions

Light irradiation intensity at nozzle orifice: 0.13 mW/cm²

Core composition feed rate: 0.3 mL/min

Cladding composition feed rate: 0.3 mL/min

Inner diameter of double-tube nozzle inner tube: 1.6 mm

Outer diameter of double-tube nozzle inner tube: 2 mm

Inner diameter of double-tube nozzle outer tube: 3.4 mm

UV irradiation intensity: 1800 mW/cm² (as a total of irradiation from three directions; 600 mW/cm² per one direction)

Take-up speed: 400 mm/second

Results

An optical fiber in a length of 150 m could be produced without fiber breakage during production. The optical fiber had a uniform diameter and had a core-cladding structure having a core diameter of 100 μm and a cladding diameter of 200 μm. The optical fiber had a circularity (aspect ratio) of 1.0 both in the core and in the cladding.

### Example 2

### Optical-Fiber Production Apparatus

The optical-fiber production apparatus illustrated in FIG. 14 was employed as in Example 1.

Optical Fiber Production

An optical fiber was produced by the procedure of Example 1, except for feeding the core composition at a feed rate as follows.

Experimental Conditions

Light irradiation intensity at nozzle orifice: 0.13 mW/cm²

Core composition feed rate: 0.075 mL/min

Cladding composition feed rate: 0.3 mL/min

Inner diameter of double-tube nozzle inner tube: 1.6 mm

Outer diameter of double-tube nozzle inner tube: 2 mm

Inner diameter of double-tube nozzle outer tube: 3.4 mm

UV irradiation intensity: 1800 mW/cm² (as a total of irradiation from three directions; 600 mW/cm² per one direction)

Take-up speed: 400 mm/second

Results

An optical fiber in a length of 150 m could be produced without fiber breakage during production. The optical fiber had a uniform diameter and had a core-cladding structure with a core diameter of 50 μm and a cladding diameter of 130 μm. The optical fiber had a circularity (aspect ratio) of 1.0 both in the core and in the cladding. By feeding the core composition at a lower discharging rate than that in Example 1, the resulting optical fiber could have a smaller diameter while maintaining a core-cladding structure thereof without suffering from fiber breakage. This demonstrates that control of the discharging rate(s) enables production of an optical fiber having an arbitrary fiber diameter (ratio between the core diameter and the cladding diameter).

### Comparative Example 1

### Optical-Fiber Production Apparatus

The production apparatus illustrated in FIG. 15 was used as an optical-fiber production apparatus. Reference sign 1 in the optical-fiber production apparatus illustrated in FIG. 15 stands for a double-tube nozzle. The double-tube nozzle 1 had inner diameters of the outer tube and the inner tube as follows as with the double-tube nozzle used in Examples 1 and 2. The optical-fiber production apparatus illustrated in FIG. 15 employed a light irradiator capable of applying light to photocurable compositions 2 from three directions. The light irradiator included three light guides (UV light guides) whose tips were arranged at the same height equidistantly from the photocurable composition 2. The tips were arranged at regular intervals from one another (at intervals of 120° from one another around the photocurable composition). This light irradiator corresponded to the light irradiator illustrated in FIG. 5, except for removing the light-shielding tubes 51 therefrom. The light irradiator employed a light source “SPOTCURE SP9-250DB” (supplied by Ushio Inc.). FIG. 15 illustrates only two light guide tips for convenience.

With reference to FIG. 15, the light guide tips 41 were arranged below the orifice of the double-tube nozzle 1 so that a height (vertical dimension) from the orifice of the double-tube nozzle 1 to the output terminal (central part of the output terminal) of each light guide tip 41 be 20 mm and that the distance between the output terminals (central part of the output terminal) of the light guide tips 41 and the photocurable compositions 2 be 15 mm.

The optical-fiber production apparatus illustrated in FIG. 15 differed from the optical-fiber production apparatus used in Examples 1 and 2 (see FIG. 14) in that the light-shielding tubes and the light-shielding plate (reference signs 51 and 52, respectively, in FIG. 14) were not arranged; and that the light guide tips 41 were arranged horizontally (at an angle formed between the light guide tips 41 and the horizontal plane of 0°).

Optical Fiber Production

Initially, the core composition and the cladding composition were fed at feed rates as follows using metering pumps 71 and 72 and simultaneously discharged vertically downward from the orifice of the double-tube nozzle 1. In the double-tube nozzle 1, the core composition was fed through the inner tube, whereas the cladding composition was fed through space between the outer tube and the inner tube.

Next, the light irradiator (light guide tips 41) arranged below the orifice of the double-tube nozzle 1 applied ultraviolet rays to the core composition and the cladding composition to cure the compositions to give an optical fiber. The produced optical fiber (plastic optical fiber) was collected by a winder 8.

Experimental Conditions

Light irradiation intensity at nozzle orifice: 0.28 mW/cm²

Core composition feed rate: 0.3 mL/min

Cladding composition feed rate: 0.3 mL/min

Inner diameter of double-tube nozzle inner tube: 1.6 mm

Outer, diameter of double-tube nozzle inner tube: 2 mm

Inner diameter of double-tube nozzle outer tube: 3.4 mm

UV irradiation intensity: 1800 mW/cm² (as a total of irradiation from three directions; 600 mW/cm² per one direction)

Take-up speed: 400 mm/second

Results

The photocurable compositions (core composition and cladding composition) discharged from the double-tube nozzle had an unstable fiber diameter to cause fiber breakage at a length of an optical fiber of 1 m or less. This impeded continuous fiber forming (optical fiber production).

### INDUSTRIAL APPLICABILITY

An optical-fiber production apparatus according to an embodiment of the present invention enables easy production of an optical fiber having a uniform diameter from a photocurable composition as a material and enables continuous fiber forming without the occurrence of fiber breakage during production. An optical fiber produced by the optical-fiber production apparatus is widely usable typically for optical communications and for ornamental purposes.

### REFERENCE SIGNS LIST

1 nozzle (double-tube nozzle)
   11 orifice
   12 outer tube
   13 inner tube
   14 adjusting screw
2 photocurable composition
   21 position through which photocurable composition is to pass
3 optical fiber
4 light irradiator
   41 light guide tip
   42 light guide
   43 light source
   44 base (support)
   45 base (support)
   46 irradiation-angle regulatory mechanism
   47 reflector
   48 condenser
51 light-shielding tube
52 light-shielding plate
53 hole through which photocurable composition is to pass
54 light-shielding ring
61 maximum-intensity light
62 light beam having an irradiation intensity of 3% of that of maximum-intensity light
63 divergence angle (ψ)
71 metering pump (for core composition feeding)
72 metering pump (for cladding composition feeding)
8 winder

1. An apparatus for producing an optical fiber by applying light to a photocurable composition to cure the composition, the apparatus comprising:
a nozzle for discharging the photocurable composition into a fiber, the nozzle comprising an orifice;
a light irradiator for applying light to the fibrous photocurable composition discharged from the nozzle; and
a controller that controls an irradiation intensity of the light to 0.2 mW/cm² or less at the nozzle orifice.

2. The apparatus of claim 1, wherein the nozzle is a double-tube nozzle comprising: an outer tube; and an inner tube arranged inside the outer tube.

3. The apparatus of claim 1, wherein the apparatus is configured to control a minimum θ of angles so as to satisfy a condition as specified by Expression (I), where the angles are formed between a direction and a plane, the direction is a direction of a light beam having a maximum irradiation intensity among light beams emitted from the light irradiator, the plane is a plane perpendicular to a discharging direction of the photocurable composition, and Expression (I) is expressed as follows:
θ≧ψ/2 (I)
wherein ψ represents a maximum of angles formed between light beams each having an irradiation intensity of 3% of the maximum irradiation intensity, the light beams belonging to the light beams emitted from the light irradiator.

4. A method for producing an optical fiber by applying light to a photocurable composition to cure the composition, the method comprising the step of:
discharging a photocurable composition into a fiber through a nozzle and applying light to the fibrous photocurable composition discharged from the nozzle, the nozzle comprising an orifice,
wherein the step further comprises controlling an irradiation intensity of the light to 0.2 mW/cm² or less at the nozzle orifice.

5. The method of claim 4, further comprising the step of preparing, as the nozzle, a double-tube nozzle comprising an outer tube and an inner tube arranged inside the outer tube, wherein the method produces an optical fiber having a core-cladding structure through the double-tube nozzle.

6. The method of claim 4, wherein the light is applied to the photocurable composition so that a minimum θ of angles satisfies a condition as specified by Expression (I), where the angles are formed between a direction and a plane, the direction is a direction of a light beam having a maximum irradiation intensity among light beams emitted from the light irradiator, the plane is a plane perpendicular to a discharging direction of the photocurable composition, and Expression (I) is expressed as follows:
θ≧ψ/2 (I)
wherein ψ represents a maximum of angles formed between light beams each having an irradiation intensity of 3% of the maximum irradiation intensity, the light beams belonging to the light beams emitted from the light irradiator.

7. An optical fiber produced by the production method of claim 4.

8. The apparatus of claim 2, wherein the apparatus is configured to control a minimum θ of angles so as to satisfy a condition as specified by Expression (I), where the angles are formed between a direction and a plane, the direction is a direction of a light beam having a maximum irradiation intensity among light beams emitted from the light irradiator, the plane is a plane perpendicular to a discharging direction of the photocurable composition, and Expression (I) is expressed as follows:
θ≧ψ/2 (I)
wherein ψ represents a maximum of angles formed between light beams each having an irradiation intensity of 3% of the maximum irradiation intensity, the light beams belonging to the light beams emitted from the light irradiator.

9. The method of claim 5, wherein the light is applied to the photocurable composition so that a minimum θ of angles satisfies a condition as specified by Expression (I), where the angles are formed between a direction and a plane, the direction is a direction of a light beam having a maximum irradiation intensity among light beams emitted from the light irradiator, the plane is a plane perpendicular to a discharging direction of the photocurable composition, and Expression (I) is expressed as follows:
θ≧ψ/2 (I)
wherein ψ represents a maximum of angles formed between light beams each having an irradiation intensity of 3% of the maximum irradiation intensity, the light beams belonging to the light beams emitted from the light irradiator.

10. An optical fiber produced by the production method of claim 5.

11. An optical fiber produced by the production method of claim 6.
